(19) United States
(12) Patent Application Publication
(10) Pub. No.: US 2026/0080601 A1
(43) Pub. Date: Mar. 19, 2026

(54) AUTOMATIC RIGGING WITH 2D SUPERVISED LEARNING

(71) Applicant: Roblox Corporation, San Mateo, CA (US)

(72) Inventors: Wenchao MA, State College, PA (US); Dario KNEUBUEHLER, Lucerne (CH); Maurice Kyojin CHU, Belmont, CA (US); Ian SACHS, Corte Madera, CA (US); Haomiao JIANG, Cupertino, CA (US)

(73) Assignee: Roblox Corporation, San Mateo, CA (US)

(21) Appl. No.: 19/331,867

(22) Filed: Sep. 17, 2025

Related U.S. Application Data
(60) Provisional application No. 63/695,966, filed on Sep. 18, 2024.

(51) Int. Cl. G06T 13/40; G06V 10/82

(52) U.S. Cl. CPC G06T 13/40; G06V 10/82

(57) ABSTRACT

According to one aspect of the present disclosure, a method of training a deformation prediction model is provided. In some implementations, a method includes obtaining a neutral expression three-dimensional (3D) mesh and a set of facial action coding system (FACS) weights, wherein the set of FACS weights represent a target facial pose or a target facial expression. The method further includes obtaining a predicted 3D mesh from the deformation prediction model, wherein the predicted mesh is arranged to at least partially mimic the target facial pose or target facial expression, rendering a two-dimensional (2D) image from the predicted mesh, and adjusting the deformation prediction model based on one or more 2D loss functions, the one or more 2D loss functions being based on comparison of the 2D image with a groundtruth 2D image obtained from a pre-trained 2D animation model.

### CROSS-REFERENCE TO RELATED APPLICATIONS

This application claims priority under 35 U.S.C. § 119(e) to U.S. Provisional Patent Application No. 63/695,966, entitled “AUTOMATIC RIGGING WITH 2D SUPERVISED LEARNING,” filed on Sep. 18, 2024, the content of which is incorporated herein in its entirety.

### TECHNICAL FIELD

Implementations relate generally but not exclusively to online virtual experience platforms, and more particularly, to methods, systems, and computer-readable media for automatic rigging of three-dimensional (3D) assets by machine learning (ML) models.

### BACKGROUND

Online platforms, such as virtual experience platforms and online gaming platforms, can include head-rendering models that guide a user in creating a new avatar head for animation and animation models for animating avatar heads. However, training techniques for these models may suffer drawbacks including relatively long training time (e.g., due to large numbers of training epochs), lack of training data, relatively small training data size, and lack of information regarding avatar head appearance and semantic information, among other drawbacks. Games are a subset of virtual experiences, and the head-rendering techniques presented herein are applicable to other forms of virtual experiences.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect, a computer-implemented method to render an avatar head is provided, the method comprising: obtaining a neutral three-dimensional (3D) mesh of the avatar head and a set of facial action coding system (FACS) weights, wherein the set of FACS weights represent a particular facial pose or a particular facial expression for the avatar head; generating a 3D mesh of the avatar head using a deformation model, wherein the neutral 3D mesh and the set of FACS weights are provided as inputs to the deformation model, and wherein the 3D mesh at least partially matches the particular facial pose or the particular facial expression; and rendering a two-dimensional (2D) image of the avatar head from the generated 3D mesh.

Various implementations of the computer-implemented method are described herein.

In some implementations, the deformation model is a machine-learning model trained to transform neutral 3D meshes of heads into 3D meshes with a target facial pose or a target facial expression, and wherein the avatar head is associated with an avatar that is part of a 3D virtual space, and further comprising rendering the avatar with the avatar head in the 3D virtual space.

In some implementations, the 3D virtual space is a virtual experience hosted by a virtual experience platform or a preview space for viewing the avatar.

In some implementations, the deformation model is a machine-learning model that comprises a diffusion network.

In some implementations, the diffusion network comprises: a conditional diffusion portion comprising a first linear block, a plurality of conditional diffusion network blocks arranged in sequence following the first linear block, and a second linear block that follows a last conditional diffusion network block of the plurality of conditional diffusion network blocks; a second portion comprising a global encoder, wherein an output of the global encoder is provided to one or more of the plurality of conditional diffusion network blocks; and a combine function that combines outputs of the conditional diffusion portion and 3D vertex positions (V) of the neutral 3D mesh for the avatar head to generate the generated 3D mesh.

In some implementations, mesh information comprising the 3D vertex positions (V) and corresponding mesh faces (F) of the neutral 3D mesh are input to the first linear block of the conditional diffusion portion and to the global encoder.

In some implementations, the first linear block performs a first matrix multiplication using a first kernel of the mesh information to generate multiplied mesh information and applies a second kernel to convert a size of the multiplied mesh information to an input dimension that matches an input dimension for a first conditional diffusion block of the plurality of conditional diffusion network blocks.

In some implementations, a first set of features generated by the first matrix multiplication is provided as input to a first conditional diffusion network block of the plurality of conditional diffusion network blocks.

In some implementations, the second linear block performs a second matrix multiplication using a third kernel of output features from a final block of the conditional diffusion network blocks to generate multiplied output features and applies a fourth kernel to convert a size of the multiplied output features to match to a number of the 3D vertex positions.

In some implementations, the combine function modifies the 3D vertex positions from the mesh information using output features from the second linear block to generate a set of mesh deformations for the particular facial pose or the particular facial expression.

In some implementations, the set of facial action coding system (FACS) weights are organized as a FACS vector, and the FACS vector is input to one or more of the plurality of conditional diffusion network blocks.

In some implementations, the computer-implemented method further comprises training the deformation model by adjusting one or more parameters of one or more of the plurality of conditional diffusion network blocks based on a value of a 2D loss function, wherein the value of the 2D loss function is based on a comparison of the 2D image of the avatar head with a groundtruth 2D image of the avatar head obtained from a trained 2D animation model, wherein the groundtruth 2D image of the avatar head has the particular facial pose or the particular facial expression.

In some implementations, the computer-implemented method further comprises training the deformation model by adjusting one or more parameters of one or more of the plurality of conditional diffusion network blocks based on a value of a 3D loss function, wherein the value of the 3D loss function is based on comparison of the 3D mesh with a groundtruth 3D mesh of the avatar head that has the particular facial pose or the particular facial expression.

According to another aspect, a non-transitory computer-readable medium is provided. The non-transitory computer-readable medium has instructions stored thereon that, responsive to execution by a processing device, cause the processing device to perform or control performance of operations comprising: obtaining a neutral three-dimensional (3D) mesh of an avatar head and a set of facial action coding system (FACS) weights, wherein the set of FACS weights represent a particular facial pose or a particular facial expression for the avatar head; generating a 3D mesh of the avatar head using a deformation model, wherein the neutral 3D mesh and the set of FACS weights are provided as inputs to the deformation model, and wherein the 3D mesh at least partially matches the particular facial pose or the particular facial expression; and rendering a two-dimensional (2D) image of the avatar head from the generated 3D mesh.

Various implementations of the non-transitory computer-readable medium are described herein.

In some implementations, the deformation model is a machine-learning model trained to transform neutral 3D meshes of heads into 3D meshes with a target facial pose or a target facial expression, and wherein the avatar head is associated with an avatar that is part of a 3D virtual space, and wherein the operations further comprise rendering the avatar with the avatar head in the 3D virtual space.

In some implementations, the deformation model is a machine-learning model that comprises a diffusion network.

In some implementations, the diffusion network comprises: a conditional diffusion portion comprising a first linear block, a plurality of conditional diffusion network blocks arranged in sequence following the first linear block, and a second linear block that follows a last conditional diffusion network block of the plurality of condition diffusion network blocks; a second portion comprising a global encoder, wherein an output of the global encoder is provided to one or more of the plurality of conditional diffusion network blocks; and a combine function that combines outputs of the conditional diffusion portion and 3D vertex positions (V) of the neutral 3D mesh for the avatar head to generate the generated 3D mesh.

According to another aspect, a system is disclosed, comprising: a memory with instructions stored thereon; and a processing device, coupled to the memory, the processing device configured to access the memory, wherein the instructions when executed by the processing device cause the processing device to perform or control performance of operations comprising: obtaining a neutral three-dimensional (3D) mesh of an avatar head and a set of facial action coding system (FACS) weights, wherein the set of FACS weights represent a particular facial pose or a particular facial expression for the avatar head; generating a 3D mesh of the avatar head using a deformation model, wherein the neutral 3D mesh and the set of FACS weights are provided as inputs to the deformation model, and wherein the 3D mesh at least partially matches the particular facial pose or the particular facial expression; and rendering a two-dimensional (2D) image of the avatar head from the generated 3D mesh.

Various implementations of the system are described herein.

In some implementations, the deformation model is a machine-learning model trained to transform neutral 3D meshes of heads into 3D meshes with a target facial pose or a target facial expression, and wherein the avatar head is associated with an avatar that is part of a 3D virtual space, and wherein the operations further comprise rendering the avatar with the avatar head in the 3D virtual space.

In some implementations, the deformation model is a machine-learning model that comprises a diffusion network.

According to yet another aspect, portions, features, and implementation details of the systems, methods, apparatuses, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a block diagram illustrating the avatar head modeling component of FIG. 1, in accordance with some implementations.

FIGS. 3A-3C are schematics of example visualizations of deformation prediction models for an avatar head, in accordance with some implementations.

FIG. 4 is a block diagram of an example conditional diffusion network, in accordance with some implementations.

FIG. 5A is an example of an artist-created facial mesh dataset, in accordance with some implementations.

FIG. 5B is a schematic of an example 2D animation model, in accordance with some implementations.

FIG. 5C is a schematic of an example 2D animation model, in accordance with some implementations.

FIG. 6 is a schematic of an example method to train a deformation prediction model, in accordance with some implementations.

FIG. 7 illustrates experimental results obtained by implementing the dataset of FIG. 5A in conjunction with the methods illustrated in FIG. 5B and FIG. 5C, in accordance with some implementations.

FIG. 8 is a flowchart of an example method to train a 2D animation model, in accordance with some implementations.

FIG. 9 is a flowchart of an example method to train a deformation prediction model, in accordance with some implementations.

FIG. 10 is a flowchart of an example method to render an avatar head, in accordance with some implementations.

FIG. 11 is a schematic illustrating an auto-rigging framework that supports facial meshes, in accordance with some implementations.

FIG. 12A is a schematic illustrating a facial mesh deformation model, in accordance with some implementations.

FIG. 12B is a schematic illustrating details of a conditional diffusion block, in accordance with some implementations.

FIG. 12C is a schematic illustrating details of a global encoder, in accordance with some implementations.

FIG. 13 is an illustration of examples of 2D displacement supervision, in accordance with some implementations.

FIG. 14 is an illustration of results obtained using various methods and/or models described herein, in accordance with some implementations.

FIG. 15 is an illustration of results on artist-crafted unrigged heads, in accordance with some implementations.

FIG. 16 is an illustration of results comparing auto-rigging results per techniques described herein with results from an alternative technique, in some implementations.

FIG. 17 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various implementations are described herein in the context of three-dimensional (3D) avatars that are used in a 3D virtual experience or environment. Some implementations of the techniques described herein may be applied to various types of 3D virtual environments, such as a virtual reality (VR) conference, a 3D session (e.g., an online lecture or other type of presentation involving 3D avatars), a virtual concert, an augmented reality (AR) session, or in other types of 3D virtual environments that may include one or more users that are represented in the 3D virtual environment by one or more 3D avatars.

Facial rigging is used to make a static neutral facial mesh animatable by defining a set of controllable deformations. Such deformations are often represented either as blendshape rigs driven by activated action units in FACS-based systems or as skeletal rigs driven by joint positions. This is an important step for creators that create avatar heads, e.g., for use by an avatar placed in a virtual experience. These capabilities bring digital avatars to life by enabling expressive and realistic facial movements across a wide range of applications. However, creating a rig for facial animation manually is laborious and expensive, often requiring skilled artists to spend tens of hours to complete a single asset.

Various implementations discussed herein provide an automated (fully or semi-automated) and generalizable facial rigging framework. Such a framework reduces or eliminates reliance on manual labor while achieving high-quality facial rigging.

Some prior facial auto-rigging methods transfer a complete set of blendshapes from a predefined template mesh to a neutral target facial mesh. A blendshape rig is a 3D rigging technique that uses pre-defined facial or body shapes (called blendshapes or morph targets) that are blended together to create new poses and expressions. Instead of manipulating individual bones, animators adjust a set of sliders that control the strength or intensity of each blendshape, smoothly morphing the base model to a target pose or expression. This technique is particularly useful for creating complex, realistic facial animations and other nuanced deformations on characters.

Such an approach often involves dense correspondences or a fixed mesh topology between the template and the target. Some prior approaches utilize per-face vector quantized variational autoencoders (VQ-VAEs) to build transferable latent spaces between faces or triangulation-agnostic networks to bypass these aspects. A template blendshape rig is still used. This scenario can compromise accuracy when the template and target shapes differ substantially from each other.

Neural face rigging (NFR) is an alternative prior approach that is capable of directly rigging facial meshes from explicitly controllable FACS parameters without relying on a template. NFR has been demonstrated primarily on humanoid heads.

Furthermore, alternative prior approaches, including NFR, do not accommodate meshes with multiple disconnected components, such as eyeballs or mouthbag (a hollow, sack-like cavity in a 3D head, which houses the teeth, tongue and gums, permitting realistic movement and animation of the mouth). This difficulty limits the ability of such alternative approaches to animate highly expressive avatars; for example, an “eye lookdown” pose is difficult to reproduce if the mesh lacks eyeballs.

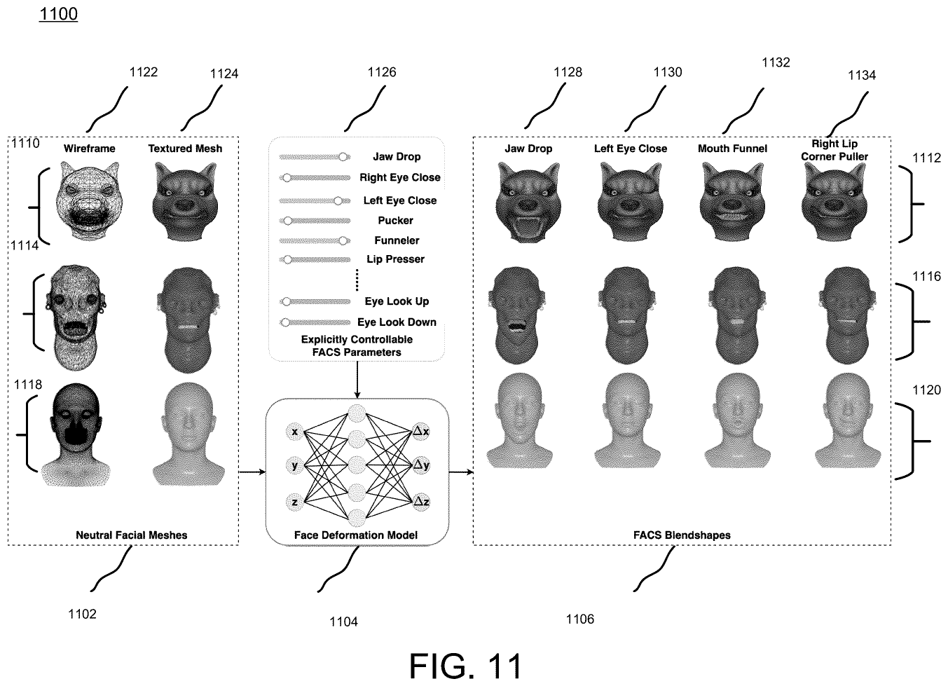

To address one or more of the above challenges, various implementations described herein provide a facial auto-rigging framework with one or more of the following advantageous aspects. First, the framework eliminates a reliance on predefined template blendshapes. This feature removes the constraint that target facial meshes are to rigorously resemble a predefined template. Second, the framework is capable of animating in-the-wild facial meshes (arbitrary facial meshes) with varying topologies and shapes, including humanoid and non-humanoid samples, e.g., as illustrated in FIG. 11. Third, the framework supports facial meshes with multiple disconnected components. This support provides a feature to enable realistic and expressive 3D face animations.

Various implementations provide a scalable and generalizable framework for facial auto-rigging. The implementations employ a facial mesh deformation network built on a triangulation-agnostic backbone for meshes of different topologies. Guided by explicitly controllable facial action coding system (FACS) parameters, the deformation network deforms a neutral facial mesh into a predefined set of FACS poses to form a blendshape rig.

Various implementations provide a conditional diffusion block that incorporates FACS parameters as additional conditional inputs. Second, some implementations provide a global encoder designed to capture holistic mesh characteristics. The global encoder enables effective handling of multiple disconnected components.

To train the deformation network, a large dataset of facial meshes is gathered (e.g., thousands or even more facial meshes). The dataset may encompass a wide variety of (face) shapes with detailed disconnected components such as eyeballs and teeth. A subset of these meshes may be meticulously rigged by professional artists to provide accurate groundtruth data for 3D deformations. Relying solely on rigged heads for training may limit the generalizability of models trained based on the dataset. The limited generalizability may occur based on the scarcity of rigged samples due to the high cost of manual rigging.

Some implementations employ 2D supervision. In some contexts, 2D supervision may offer better accessibility and broader scalability compared to 3D supervision. Some implementations may utilize a 2D supervision strategy for 3D facial mesh deformation models. Such a strategy integrates use appearance guidance from images, e.g., Red-Green-Blue (RGB) images or any other suitable type of images, for prominent facial expressions and motion guidance from an optical flow-like 2D displacement field for subtle micro-expressions.

Various implementations may be supported by a generative 2D face animation model that synthesizes posed images from the renderings of a neutral mesh, along with an optical flow estimator that predicts the 2D displacement between neutral and posed images as 2D supervisions. Accordingly, various implementations may expand the training dataset using unlabeled neutral meshes without rigs.

This expansion enables the network to effectively distill rigging knowledge across diverse facial shapes. Such distilling can result in more accurate and generalizable 3D facial animations even with limited labeled training data. Various techniques described herein outperform alternative assets from diverse sources, including artist-crafted meshes (obtained and used for specific purposes with appropriate permissions from artists).

In addition, various implementations provide for various downstream applications of the auto-rigging system in user-controlled animation, retargeting human expressions from videos, and rigging generated facial meshes from a text-to-3D model. Some implementations provide a scalable neural auto-rigging framework usable for facial meshes of diverse topologies, including those with multiple disconnected components.

Various implementations deform a static neutral facial mesh into FACS poses to form an expressive blendshape rig. In some implementations, deformations are predicted by a triangulation-agnostic surface learning network augmented with a tailored architecture design to condition on FACS parameters and efficiently process disconnected components. For training, implementations may use a curated dataset of facial meshes, with a subset manually rigged by professional artists to serve as accurate 3D groundtruth for deformation supervision. Due to the high cost of such manual rigging, this subset may be limited in size. This, in some cases, may constrain generalization ability of models trained exclusively on such a dataset.

To address this issue, various implementations utilize a 2D supervision strategy for unlabeled neutral meshes without rigs. This strategy can increase data diversity and can enable a larger scale of training, thereby enhancing the generalization ability of models trained on this augmented data. Experiments demonstrate that implementations are able to rig meshes of diverse topologies on not just the artist-crafted assets but also in-the-wild samples, indicating a high degree of generalizability. Moreover, the techniques can support multiple disconnected components, such as eyeballs, for detailed expression animation.

In some implementations, systems, methods, and non-transitory computer-readable media are provided to manipulate 3D assets and/or to create new 3D assets that are of practical use in a 3D virtual experience and/or other applications. For example, practical 3D assets are 3D assets that are one or more of: easy to animate with a low computational load, suitable for visual presentation in a virtual environment on a client device of any type, suitable for multiple different forms of animation, suitable for different skinning methodologies, suitable for different skinning deformations, suitable for different caging methodologies, and/or suitable for animation on various client devices.

Online platforms, such as online virtual experience platforms, generally provide an ability to create, edit, store, and otherwise manipulate virtual items, virtual avatars, and other practical 3D assets to be used in virtual experiences.

For example, virtual experience platforms may include user-generated content or developer-generated content (each referred to as “UGC” herein). The UGC may be stored and implemented through the virtual experience platform, for example, by permitting users to search and interact with various virtual elements to create avatars and other items.

Users may select and rearrange various virtual elements from various virtual avatars and 3D models to create new models and avatars. Avatar creators can create character heads with geometries of any target/customized shape and size and publish the heads in a head library, e.g., hosted by the virtual experience platform.

At runtime during a virtual experience or other 3D session, a user may access the head library to select a particular head (including various parts such as eyes, lips, nose, ears, hair, facial hair, etc.), and to rearrange the head (or parts thereof). According to implementations described herein, the virtual experience platform may take as input the overall model of the head (or parts thereof) and infer a skeletal structure that permits appropriate motion (e.g., joint movement, rotation, etc.). In this manner, many different avatar head parts may be rearranged to enable dynamic avatar head creation without detracting from a user experience.

The implementations described herein are based on the concept of meshes and rigs. As used herein, the term “mesh” refers to graphical representations of head parts (e.g., eyes, nose, lips, ears, chin, cheeks, ears, forehead, etc.) and can be of arbitrary shape, size, and geometric topology. The term “rig” refers to a virtual armature made up of a plurality of joints that are used to animate (pose) the mesh. The rig has a strong correspondence to the corresponding vertices of the mesh.

Conventionally, to animate a character, a creator may first generate a rig that includes joints and skinning weights. There are many things that go into creating a successful rig. One of the most important is properly skinning the rig to the avatar head. Without skinning, the mesh does not deform correctly, and the animation of the avatar's face lacks realism. “Skinning” refers to the placement and correlation of joints with respect to the mesh. This means that the joints have influence on the vertices on the mesh and move the vertices according to various poses. Skinning is relevant for creating an avatar that moves accurately and also an avatar that deforms properly.

Skinning generally involves two operations: binding and weight painting. Binding is the process by which the joints are positioned (or “bound”) with respect to the mesh. Once the joints are bound to the mesh, weight painting is performed to manually assign the proper weighted influence each joint has on the different vertices of the mesh.

For instance, the joint around the eye of a character most likely only controls that area. If the eye joint were to move and influence the vertices associated with the mouth, the pose may lack realism. Skinning is often done by hand. Because a rig is generally made up of many individual joints, and the joints each influence a different combination of vertices of the mesh in different ways, skinning is a time and labor-intensive process for a creator.

Before skinning can be performed, predictions of the mesh-vertex positions for different facial poses is to be performed. Surface learning methods are to generalize to shapes represented differently from the training set to be useful in practice, yet many existing approaches depend strongly on mesh connectivity.

Additionally, existing approaches do not make use of 2D groundtruth data for training (e.g., which may be easier to obtain than 3D groundtruth data). Having the possibility of training with 2D groundtruth data results in easier to obtain and less expensive training data.

To overcome these and other challenges, various implementations as described herein provide techniques for training a deformation prediction model to accurately generate a set of predicted mesh displacements for a plurality of poses (such as avatar head poses). The deformation prediction model may include one or more conditional diffusion network block(s) and a global encoder. To use such a deformation prediction model, mesh information associated with a mesh of an avatar head in a neutral pose (e.g., a mesh for a neutral expression) may be input into the conditional diffusion network block(s) and the global encoder.

The mesh information may also include a plurality of vertex positions and a correspondence between the vertex positions of the plurality of vertex positions. A plurality of pose vectors associated with the plurality of poses for prediction may also be input into the condition diffusion network block(s).

The conditional diffusion network block(s) may generate output features of the mesh based on the mesh information and the corresponding pose vectors. The global encoder may perform a global average operation over the vertices in the mesh. The global features generated by the global encoder may be input into the conditional diffusion network block(s) to increase the accuracy of the set of predicted mesh displacements for the plurality of poses. The deformation prediction model may output a predicted mesh based upon outputs of the conditional diffusion network block(s) and the global encoder.

In various implementations, training of the deformation prediction model may include two-dimensional (2D) supervised learning techniques. The 2D supervised learning techniques may be used in addition to (or as an alternative to) 3D supervised learning techniques, in some implementations. While training, the deformation prediction model outputs the predicted mesh based on the input neutral mesh. The output mesh may be rendered (e.g., using a rendering component) to provide a 2D rendered image representative of the output predicted mesh in the predicted pose.

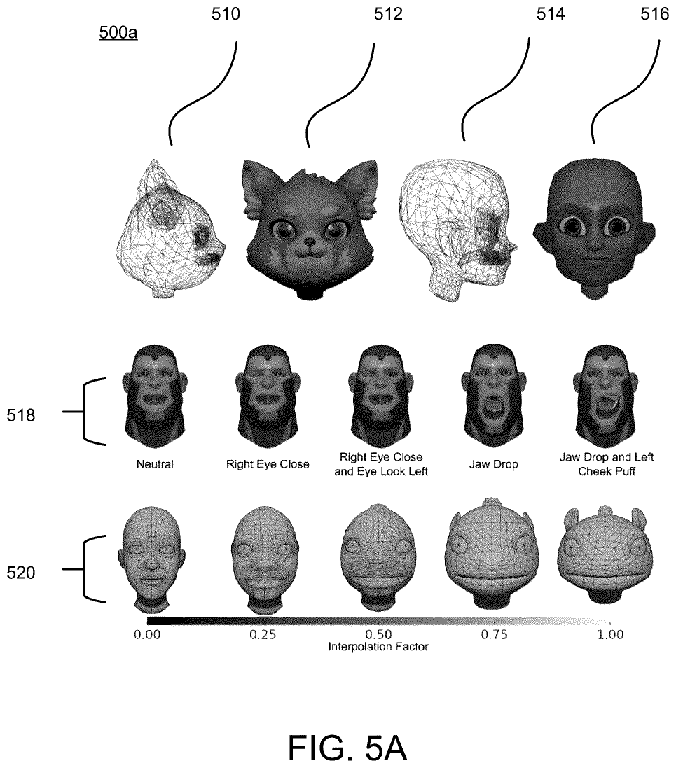

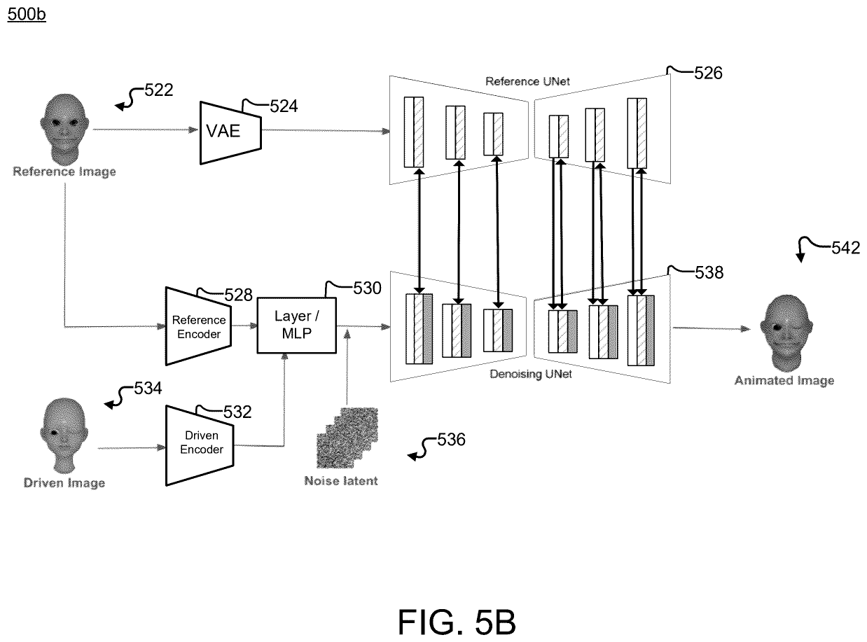

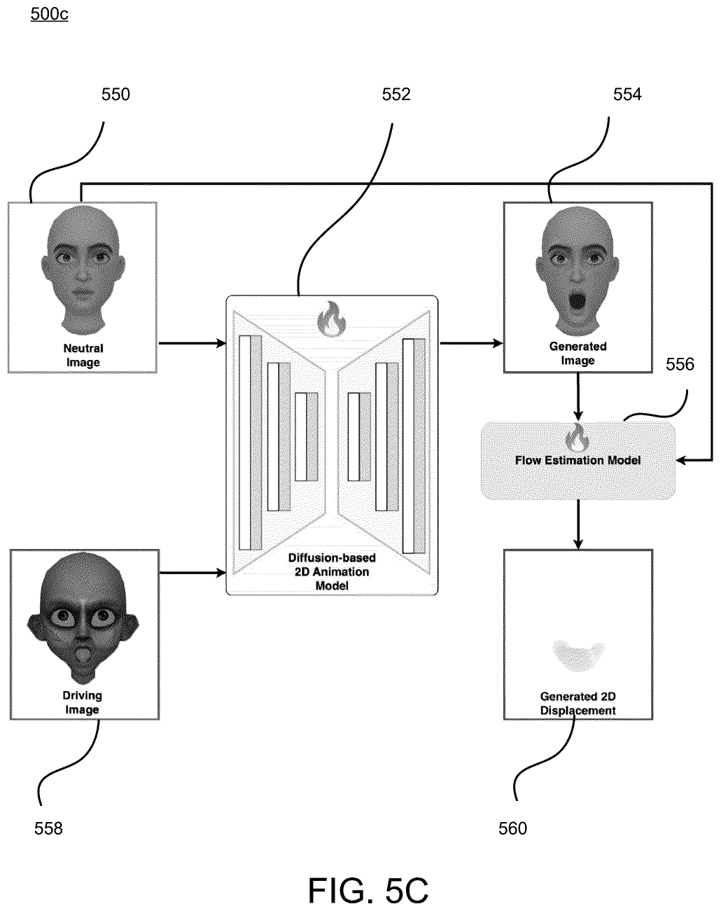

One or more loss function values, e.g., L1 or L2 loss in pixel space, landmark losses associated with 2D landmarks in pixels space, losses on displacement maps (described with reference to FIG. 5), and/or mask losses associated with occupation masks in the 2D rendered image and respective ground truth image, associated with comparison of the 2D rendered image to a groundtruth 2D image provided by a 2D animation model may be computed. The deformation prediction model may be adjusted (one or more model parameters updated) based on the computed loss function values (e.g., in a manner to reduce the loss function values). As such, in some implementations, the 3D output predicted mesh may be compared to groundtruth 3D image data during training.

In such implementations, adjustments to the deformation prediction model are based on these 2D supervised learning techniques. Furthermore, in some implementations, the predicted 3D mesh (output of the model) may be compared to groundtruth 3D meshes in the predicted pose of the predicted mesh, using a 3D supervised learning technique (where the loss function is indicative of a difference between the groundtruth 3D mesh and the predicted 3D mesh in the predicted pose). One or more of the 2D supervised learning techniques and 3D supervised learning techniques may be implemented in training the deformation prediction models, in some implementations.

### 3D Surface Learning Network

The current backbone network is based upon a 3D surface learning network inspired by a heat diffusion process. Starting with per-vertex features, the network diffuses information across the 3D surface using the intrinsic Laplace-Beltrami operator, then adds lightweight multi-layer perceptrons (MLPs) for non-linearity.

Because diffusion depends on surface intrinsic geometry alone, the same learned weights transfer across meshes with different resolutions or triangulation, making the model compact, discretization-agnostic, and effective for tasks such as classification and regression on geometric data. In techniques provided herein, the backbone network according to various implementations is built upon such a 3D surface learning network.

### Linear FACS Blendshape Rig

The linear facial action coding system (FACS) blendshape rig models an animatable 3D face using a neutral mesh M₀=(V₀, F), where V₀ represents the vertex positions and F the mesh connectivity. The blendshape rig also defines a set of N blendshapes

$${\{ {M}_{i} = ( {V}_{i} , F ) \}}_{i = 1}^{N}$$

each obtained by adding a vertex offset dᵢ to the neutral mesh Vᵢ=V₀+dᵢ.

Each blendshape corresponds to an action unit (AU) from the facial action coding system (FACS), representing specific muscle movements, such as “Right Eye Close.” Complex facial expression animation, involving the activation of multiple action units, is achieved by assigning a weight wᵢ ∈[0,1] to each blendshape and computing the final mesh M=(V, F), where

$$V = {V}_{0} + {\sum }_{i = 1}^{N} {w}_{i} {d}_{i} .$$

There are various real-world applications of the auto-rigging framework described herein. A first example application includes user-controlled animation, where the predicted FACS rig permits users to pose a mesh by editing FACS parameters. A second example application includes video-to-mesh retargeting, which transfers expressions of a subject in the video via tracked FACS sequences to an unrigged mesh. A third example application includes animating a facial mesh generated from a text-to-3D model, turning the facial mesh from a neutral facial mesh into a fully animatable avatar.

Thus, various implementations provide a framework for auto-rigging facial meshes. Powered by a tailored design for multiple disconnected components and FACS conditioning and trained on unrigged heads with 2D supervision (and/or 3D supervision), the framework (and trained machine learning models) can be used to animate meshes of diverse topologies with even multiple disconnected components, across both artist-crafted assets and in-the-wild samples.

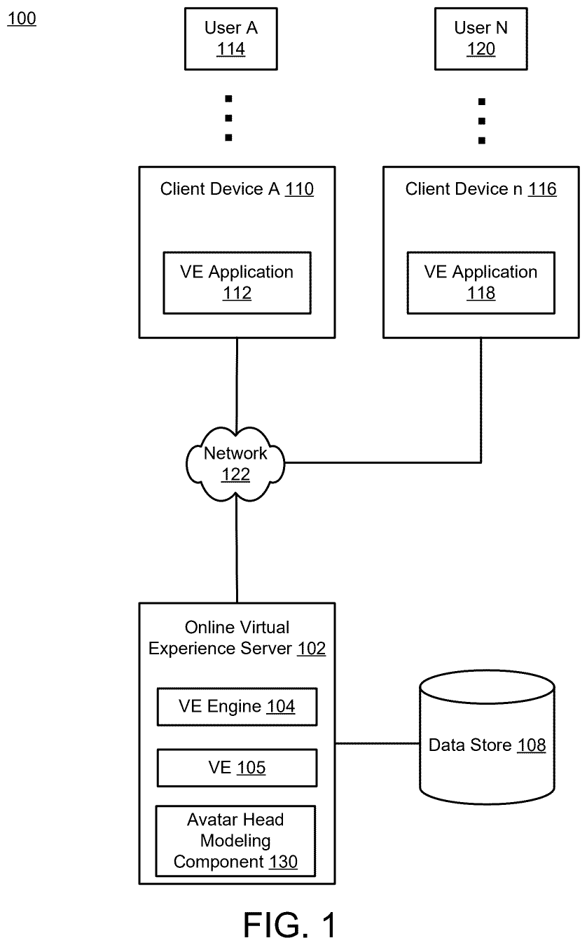

FIG. 1 illustrates an example network environment 100, in accordance with some implementations. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, a client device 110 (or multiple client devices), and a third party server 118, all connected via a network 122.

The online virtual experience server 102 can include, among other things, a virtual experience engine 104, one or more virtual experiences 105, and an avatar head modeling component 130. The online virtual experience server 102 may be configured to provide virtual experiences 105 to one or more client devices 110, and to provide automatic generation of avatar heads via the avatar head modeling component 130, in some implementations.

Data store 108 is shown coupled to online virtual experience server 102 but in some implementations, can also be provided as part of the online virtual experience server 102. The data store may, in some implementations, be configured to store advertising data, user data, engagement data, avatar head data, and/or other contextual data in association with the avatar head modeling component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include virtual user engagement portals as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 1002.11 network, a Wi-Fi® network, or wireless LAN (WLAN)), a cellular network (e.g., a long term evolution (LTE) network), routers, hubs, switches, server computers, or a combination thereof.

In some implementations, the data store 108 may be a non-transitory computer-readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user 114 via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. However, virtual experiences are not limited to games, and other types of virtual experiences may be used in some implementations. In some implementations, virtual experience creators and/or developers may search for virtual experiences, combine portions of virtual experiences, tailor virtual experiences for particular activities (e.g., group virtual experiences), and other features provided through the online virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience or another graphical user interface (GUI) of the online network environment 100, a user may create an avatar head that includes different head parts (e.g., head shapes, eyes, noses, mouths, chins, lips, cheeks, jawlines, brow lines, hair lines, ears, etc.) from different libraries. The avatar head modeling component 130 may take as input a mesh associated with a target avatar head.

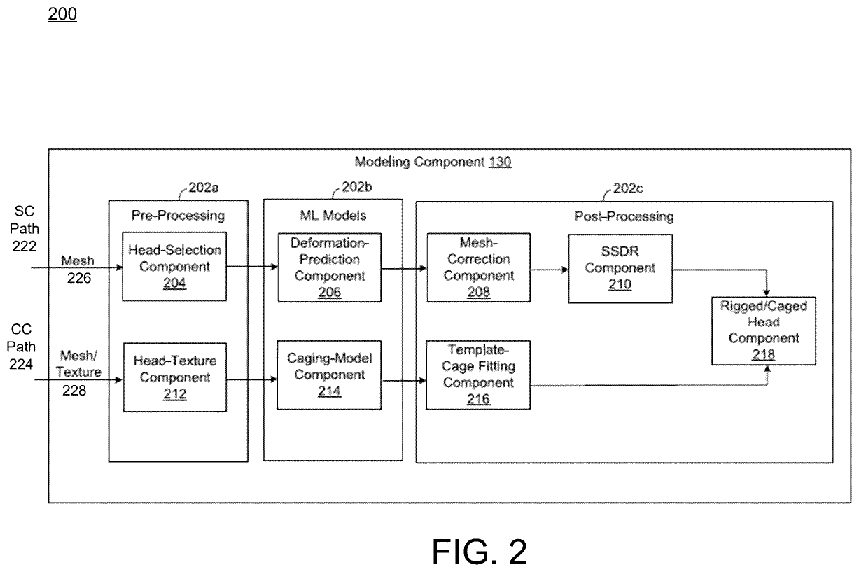

Hereinafter, a more detailed discussion of the structure of and operation of avatar head modeling component 130 is presented with reference to FIGS. 2-4.

FIG. 2 is a block diagram 200 illustrating the avatar head modeling component 130 of FIG. 1, in accordance with some implementations. The avatar head modeling component 130 may include a pre-processing module 202a, a machine-learning (ML) model module 202b, and a post-processing module 202c.

The pre-processing module 202a may include a head-selection component 204 and a head-texture component 212. The ML model module 202b may include a deformation prediction component 206 (also referred to as a deformation prediction model) and a caging-model component 214. The post-processing module 202c may include a mesh-correction component 208, a smooth skinning decomposition with rigid bones (SSDR) component 210, a cage-fitting component 216, and a rigged/caged head component 218.

The avatar head modeling component 130 may be arranged with a skinning-computational (SC) path 222 (which receives as path input mesh information) and a caging-computational (CC) path 224 (which receives as path input mesh/texture information). The skinning-computational path 222 may include one or more of, e.g., the head-selection component 204, the deformation prediction component 206, the mesh-correction component 208, and the SSDR component 210. The skinning-computational path 222 acts to determine how skinning may occur for the mesh.

The caging-computational path 224 may include one or more of, e.g., the head-texture component 212, the caging-model component 214, and the cage-fitting component 216. The rigged/caged head component 218 may be considered part of the skinning-computational path 222 and the caging-computational path 224 or separate from both. The caging-computational path 224 acts to determine how texturing may be performed as cage fitting. The operations performed by each component of the skinning-computational path 222 and the caging-computational path 224 are described in greater detail below.

To begin the skinning computation (for the skinning-computational path 222), mesh information 228 associated with an avatar head in a neutral pose may be received by the head-selection component 204. In some implementations, the mesh information 228 received by the head-selection component 204 may include 3D vertex positions for the entire body (or portions thereof, including the avatar head) of the avatar in a neutral pose and corresponding mesh faces, each mesh face being defined by three or more vertices. That is, each mesh face is a polygon, such as a triangle, a quadrilateral, or another two-dimensional shape defined by connecting three or more vertices.

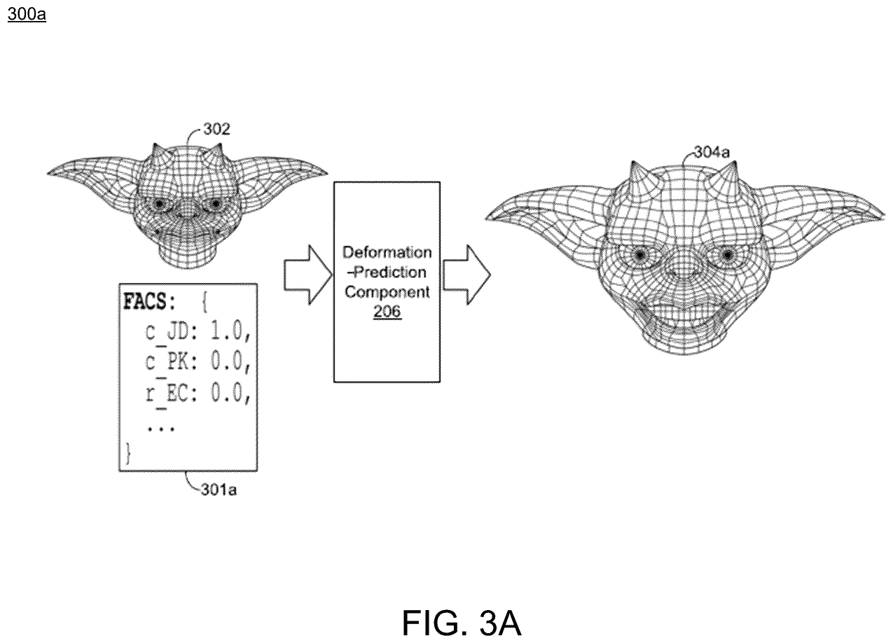

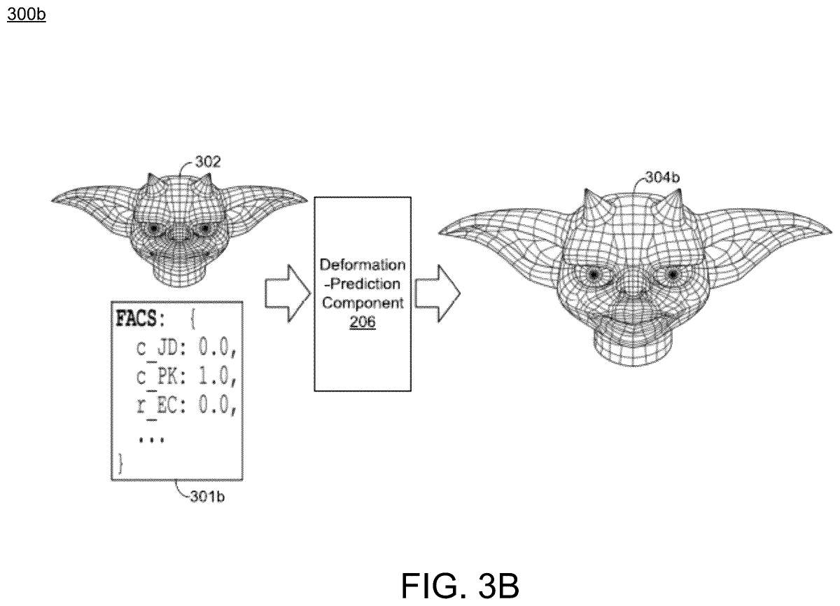

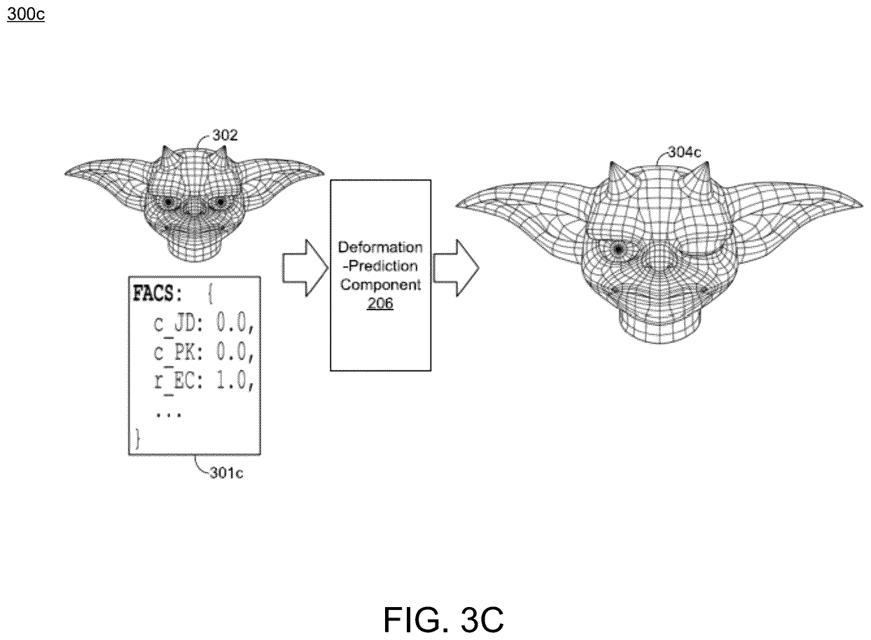

The mesh information 228 may be segmented such that vertices associated with different body parts are indicated. Using the indication of body part segmentation, the head-selection component 204 may identify the mesh portions associated with the avatar head (e.g., the avatar head, with or without an avatar neck portion). Once identified, the head-selection component 204 may provide the mesh information associated with the avatar head (or avatar head and neck) to the deformation prediction component 206. Additional details of the deformation prediction component 206 are described in connection with FIGS. 3A-3C.

FIGS. 3A-3C are schematics of an example visualization of deformation prediction models 300a, 300b, and 300c for an avatar head, in accordance with some implementations. The deformation prediction model 300 illustrated in FIGS. 3A-3C may be implemented by the deformation prediction component 206.

The deformation prediction component 206 may receive mesh information 302 associated with the avatar head in a neutral pose and corresponding facial action coding system (FACS) vectors 301a, 301b, and 301c.

The mesh information 302 may include 3D vertex positions and the corresponding mesh faces formed by groups of vertices (e.g., three or more vertices) and vertex surface normals (though the vertex surface normals can be computed from the vertices and the faces). The mesh information 302 may define the external features/geometry (e.g., eyes, nose, lips, chin, jawline, ears, forehead, etc.) and (optionally) internal features/geometry (e.g., teeth, tongue, gums, etc.) of the avatar head in the neutral pose.

For example, the mesh information 302 defines an avatar head with a neck portion corresponding to a goblin avatar. Each of the FACS vectors 301 (different examples of FACS vectors 301a, 301b, and 301c are illustrated in FIGS. 3A-3C, respectively) encodes FACS values in a vector associated with a respective static pose for prediction associated with the avatar.

The deformation prediction component 206 analyzes the mesh of the avatar head in the neutral pose based on the mesh information 302 of the avatar head. The deformation prediction component 206 deforms the mesh based on a FACS vector (such as 301a, 301b, or 301c) to predict a set of mesh deformations associated with the static pose indicated by the FACS vector (such as 301a, 301b, or 301c). The deformation prediction component 206 may deform the mesh by updating the location of a vertex to a new location associated with a static pose encoded by the FACS vector (such as 301a, 301b, or 301c).

For example, referring to FIG. 3A, the deformation prediction component 206 receives a FACS vector 301a for a “jaw-drop” pose of the avatar head. As illustrated, the FACS vector 301a encodes a FACS value of 1.0 for the jaw-drop pose (c_JD), and FACS values of 0.0 for the other poses.

Here, the deformation prediction component 206 may identify a set of vertices associated with the jaw. This set of vertices may include vertices of the lips, jaw, teeth, tongue, etc. as relevant parts of the avatar head Then, the deformation prediction component 206 may predict per-vertex displacement for each vertex in the set of vertices associated with the jaw of the avatar head.

In another example, referring to FIG. 3B, the deformation prediction component 206 receives a FACS vector 301b for a “pucker” pose of the avatar head. As illustrated, the FACS vector 301b encodes a FACS value of 1.0 for the pucker pose (c_PK), and FACS values of 0.0 for the other poses.

Here, the deformation prediction component 206 may identify a set of vertices associated with the mouth. This set of vertices may include vertices of the lips, chin, cheeks, jaw, etc. as relevant parts of the avatar head. Then, the deformation prediction component 206 may predict per-vertex displacement for each vertex in the set of vertices associated with the mouth of the avatar head.

For instance, referring to FIG. 3C, the deformation prediction component 206 receives a FACS vector 301c for an “eye-closed” pose of the avatar head. As illustrated, the FACS vector 301c encodes a FACS value of 1.0 for the pucker pose (c_EC), and FACS values of 0.0 for the other poses.

Here, the deformation prediction component 206 may identify a set of vertices associated with the left-eye. This set of vertices may include vertices of the eye lips, brow, upper cheek, etc. as relevant parts of the avatar head. Then, the deformation prediction component 206 may predict per-vertex displacement for each vertex in the set of vertices associated with the mouth of the avatar head.

Referring to FIGS. 3A-3C, in some implementations, the per-vertex displacements for each of the plurality of poses may be predicted using the conditional diffusion network, as described below.

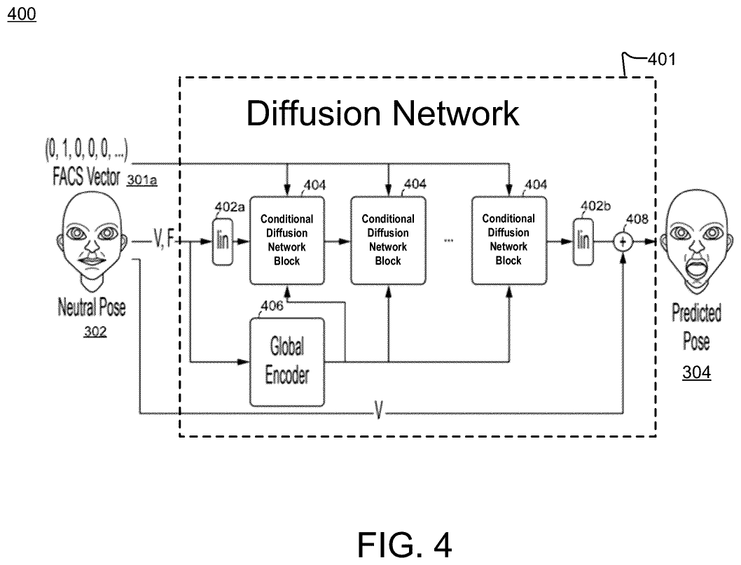

FIG. 4 is a block diagram of an example conditional diffusion network architecture 400, in accordance with some implementations. The conditional diffusion network architecture 400 may include a conditional diffusion network 401 arranged to receive a neutral expression mesh or mesh information 302 and to provide a predicted mesh or mesh deformations 304 (also referred to as a predicted pose). The conditional diffusion network 401 may include a first linear block 402a, a plurality of conditional diffusion network blocks 404 arranged in sequence, a global encoder 406, a second linear block 402b, and a combine function 408.

Mesh information 302, which indicates the 3D vertex positions (V) and corresponding mesh faces (F) of the avatar head in a neutral pose, is/are input to the first linear block 402a and input to the global encoder 406. The first linear block 402a may perform a first matrix multiplication using a first kernel and the mesh information 302.

The first linear block 402a may apply a second kernel to the result of the first matrix multiplication to convert the size of the mesh information 302 to an input dimension suitable for the plurality of conditional diffusion network blocks 404. A first set of features generated by the first matrix multiplication may be input as input features into the first of the plurality of conditional diffusion network blocks 404.

The global encoder 406 may analyze the mesh based on the mesh information 302 and provide global information to each of the conditional diffusion network blocks 404 to aid in the deformation prediction.

The second linear block 402b may perform a second matrix multiplication using a third kernel and the output features from the last of the conditional diffusion network blocks 404n. The second linear block 402b may apply a fourth kernel to convert the size of the output features received from the last of the conditional diffusion network blocks 404n back to the size of the mesh information 302.

The combine function 408 may modify the 3D vertex positions from the mesh information 302 using the output features from the second linear block 402b to generate the set of mesh deformations 304 for the static pose associated with the respective FACS vector 301 (e.g., FACS vector 301a generates mesh deformations 304a, FACS vector 301b generates mesh deformations 304b, FACS vector 301c generates mesh deformations 304c).

The operations described above with reference to FIG. 4 may be performed for any pose of a plurality of different poses of an avatar head to generate a final set of mesh deformations that may be used for skinning. Such skinning may be used for animating the avatar head.

Referring again to FIG. 2, the plurality of mesh deformations 304a, 304b, and 304c (as illustrated in FIGS. 3A-3C) predicted by the deformation prediction component 206 may be input into the mesh-correction component 208. At this stage, it is possible that the internal geometry (e.g., teeth, tongue, inner mouthbag, etc.) of the mesh may crash through (intersect) the face surface of the avatar head based on the set of mesh deformations. Mesh-correction component 208 may detect collisions between the head surface and internal geometries and take corrective action to push these internal parts to be behind the external surface of the avatar face.

Mesh-correction component 208 may identify the external surface and the internal features of the avatar head in the neutral pose based on the mesh information. The mesh faces associated with the external surface of the head mesh in neutral pose may be identified first. For instance, the mesh-correction component 208 may initially identify a first plurality of depth values associated with the external surface of the avatar head for one of the poses. The mesh-correction component 208 may also identify a second plurality of depth values associated with the internal features of the avatar head for that pose.

The mesh-correction component 208 may perform a rasterization operation directed at the front of the avatar head for the pose to identify internal features that have a larger Z-coordinate value (e.g., the second plurality of depth values) than the Z-coordinate values (e.g., the first plurality of depth values) of corresponding external features. A collision is detected by the mesh-correction component 208 when the Z-coordinate value of one of the internal features is greater than or equal to the Z-coordinate value of a corresponding one of the external features.

When a collision is detected, the mesh-correction component 208 adjusts the Z-coordinate values of the internal features for that pose to be less than the corresponding Z-coordinate values of the external features. The mesh-correction component 208 may perform these operations for each of the predicted poses. In some implementations, upon determination that there is no collision, no adjustments are performed by the mesh-correction component 208.

After the adjustment, the set of mesh deformations with mesh corrections may be provided to the Smooth Skinning Decomposition with Rigid Bones (SSDR) component 210. The SSDR component 210 may convert the set of mesh deformations 304 into a linear blend skinning (LBS) rig that is suitable for animation. The LBS rig may be provided to the rigged/caged head component 218 for any final rigging and output occurring for animation.

For example, rigged/caged head component 218 may receive the LBS rig from the SSDR component 210 and a cage from the cage-fitting component 216. Using the LBS rig received from the SSDR component 210 and the cage, the rigged/caged head component 218 may animate the avatar head. The LBS rig may be used to animate the avatar's face, while the cage may be used to animate the avatar's hair, facial hair, or head/neck clothing (e.g., hat, scarf, etc.).

As described above, a deformation prediction component may predict a plurality of mesh deformations 304 based on an input mesh. The plurality of mesh deformations may be used in an animation of the avatar head by using a rigged/caged head component. Hereinafter, additional details related to training of the deformation prediction component 206 (also referred to as a deformation prediction model) are provided.

FIG. 5A is an example 500a of an artist-created facial mesh dataset, in accordance with some implementations. The dataset may include a diverse set of artist-crafted facial meshes for model training an evaluation. As illustrated in FIG. 5A, the dataset includes facial meshes with multiple disconnected components, such as separate eyeballs and features a variety of shapes, including both humanoid and non-humanoid heads.

For example, the dataset 500a may include a first side-view wireframe mesh 510 and a first front-view textured mesh 512 for an avatar head for a wolf avatar. The dataset 500a may also include a second side-view wireframe mesh 514 and a second front-view textured mesh 516 for an avatar head for a humanoid avatar. These wireframe meshes and texture meshes are examples of neutral facial meshes.

The dataset 500a may also include a variety of poses 518 for a bearded humanoid avatar. Poses 518 include a neutral facial mesh, a right eye close facial mesh, a right eye close and eye look left mesh, a jaw drop mesh, and a jaw drop and left cheek puff mesh. The poses 518 correspond to FACS blendshape rig annotation data.

The dataset 500a may also include examples of interpolation augmentation 520, in which a first neutral facial mesh transitions smoothly into a second neutral facial mesh. For example, the interpolation augmentation illustrates a transition between a humanoid avatar head (associated with 0.00 interpolation), a slightly complete transition between the humanoid avatar head and a froglike avatar head (associated with 0.25 interpolation), a halfway transition between the humanoid avatar head and a froglike avatar head (associated with 0.5 interpolation), a mostly complete transition between the humanoid avatar head and a froglike avatar head (associated with 0.75 interpolation), and a complete transition to the froglike avatar head (associated with 1.00 interpolation).

Each dataset sample contains a neutral base mesh M₀. For a subset of heads, artists manually annotate a full blendshape rig

$${\{ {M}_{i} = ( {V}_{i} , F ) \}}_{i = 1}^{N}$$

across N FACS training poses. For example, in some implementations, N=96, comprising 48 FACS poses and 48 corrective poses. Various implementations also pair each blendshape with a one-hot-like FACS vector Aᵢ as pose representation, where activated action entries are set to 1. Furthermore, these heads were also annotated with facial landmarks specified as vertex indices. For unlabeled heads, only a neutral head mesh M₀=(V₀, F) is included.

Creating head meshes with complex rigs for animation is an expensive process. In order to expand the dataset sufficiently for training a deep neural network, some implementations use a data augmentation strategy based on a standardized UV layout. Such data augmentation enables interpolation between different head geometries through linear blending to increase the size of the dataset.

FIG. 5B is a schematic of an example 2D animation model 500b, in accordance with some implementations. As illustrated, the model 500b is arranged to receive a reference image 522 and a driven image 534 as inputs. The model 500b is arranged to provide an animated image 542 as an output. The reference image 522 may represent a 2D rendering of a 3D avatar head model, in some implementations. The driven image 534 may represent a 2D rendering of a face having a particular facial pose for animation, in some implementations.

For example, the pose of the face of the driven image 534 may represent a target pose for an output animated image 542, provided by the model 500b. In other words, the output animated image 542 may mimic the expression of the driven image 534, while keeping the identity of the reference image 522. In other words, the animation process does not change the identity of the reference image 522 but conveys onto the reference image 522 the expression of the driven image 534.

The model 500b may include a variational autoencoder (VAE) 524, a reference convolutional neural network 526 in operative communication with the VAE 524, a reference encoder 528, a driven encoder 532, a layer 530 (which may, in some implementations, be a multi-layer perceptron (MLP) layer 530) in operational communication with both of the reference encoder 528 and the driven encoder 532, and a denoising convolutional neural network 538 in operative communication with the layer 530 and the reference convolutional neural network 526. It is noted that network 526 and layer 530 may contain both convolutional blocks and attention blocks, in some implementations.

The VAE 524 is arranged to receive the reference image 522 as an input. The VAE 524 is arranged to encode features of the reference image 522. The encoded features may be provided to a reference convolutional neural network 526. The reference convolutional neural network 526 may include a U-net architecture, in some implementations. A U-net architecture includes an encoder (a contracting path) and a decoder (an expanding path).

The reference image 522 may also be provided as an input to the reference encoder 528. The reference encoder 528 may encode features of the reference image 522. Similarly, the driven image 534 may be provided as input to the driven encoder 532. The driven encoder 532 may encode features of the driven image 534. The encoded features of the reference image 522 and the encoded features of the driven image 534 may be provided as inputs to the layer 530.

The layer 530 may be implemented using one or more adaptive-layer norm-layers (adaLN), or as a multi-layer perceptron, in some implementations. For example, layer normalization is a technique in neural networks that normalizes features across the channels for a given data sample. This normalization helps stabilize training.

AdaLN builds upon layer normalization by making the normalization parameters (scale and shift) adaptive to conditioning information. This means the scale (gamma) and shift (beta) parameters are predicted form inputs like noise timestamps (t) or class labels (c). There is also a various of adaLN call adaLN-Zero where, in addition to scale and shift, it also regresses dimension-wise scaling parameters (alpha) applied before residual connections within the network block.

Output of the layer 530 and a noise latent 536 are provided to the denoising convolutional neural network 538. In the context of generative AI and particularly diffusion models, a noise latent refers to a representation of an image or other data within a compressed, abstract space (the “latent space”) that has been intentionally infused with random noise. This noise is not arbitrary; it is a carefully controlled element that helps the model explore different possibilities and generate diverse outputs.

The denoising convolutional neural network 538 may provide the animated image 542 as output. The denoising convolutional neural network 538 may include a U-net architecture, in some implementations. The U-net architecture included in the denoising convolutional neural network 538 may be similar to that of reference U-Net network 526.

The animated image 542 generated by the denoising convolutional neural network 538 may represent a new 2D groundtruth image for use in 2D supervised learning processes, as described herein. For example, FACS weights associated with the driven image 534 and the animated image 542 may be used in computing values of loss functions and corresponding adjustments to 3D models, as described more fully below.

FIG. 5C is a schematic of an example 2D animation model, in accordance with some implementations.

FIG. 5C illustrates that a neutral image 550 and a driving image 558 are provided as inputs to a diffusion-based 2D animation model 552. The flame icon associated with the diffusion-based 2D animation model 552 indicates that diffusion-based 2D animation model 552 is a trainable model. The neutral image 550 is obtained from an unrigged head. The driving image 558 is obtained from a rigged head. The neutral image 550 is also provided as input to a flow estimation model 556, which is also a trainable model. The diffusion-based 2D animation model 552 produces a generated image 554.

The neutral image 550 and the generated image 554 are provided as inputs to the flow estimation model 556. The flow estimation model 556 produces a generated 2D displacement 560.

In some implementations, a 2D supervision generation pipeline works as follows. Given a posed image rendered from a rigged head (driving image 558) and a neutral image from an unrigged head (neutral image 550), the 2D animation model (diffusion-based 2D animation model 552) generates an image (generated image 554) that replicates the expression in the posed image while preserving the identity of the neutral image.

A flow estimation model (flow estimation model 556) is then applied to the neutral (neutral image 550) and generated (generated image 554) posed images to predict the pixel offsets as 2D displacements. By using this pipeline, it is possible to generate 2D data as training data.

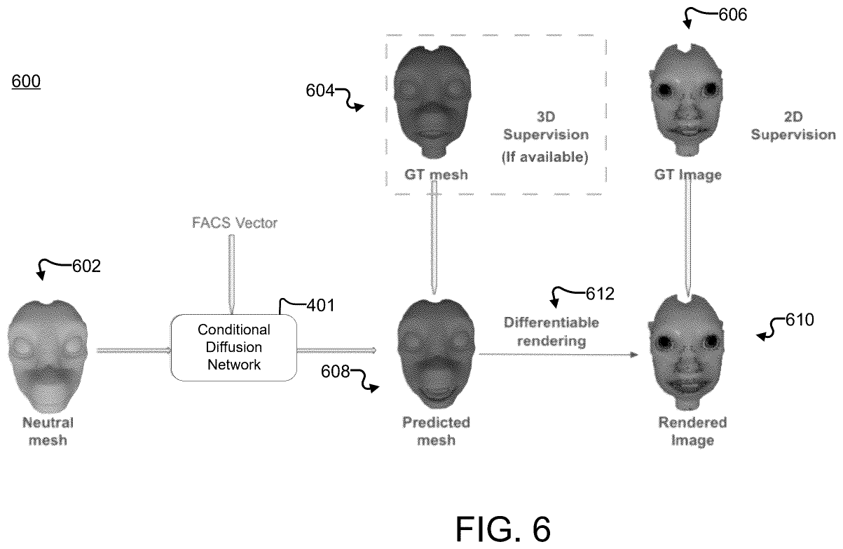

FIG. 6 is a schematic of an example method 600 to train a deformation prediction model, in accordance with some implementations. As illustrated, the deformation prediction model may include the conditional diffusion network 401 that is being trained. Furthermore, 3D supervised learning techniques and/or 2D supervised learning techniques may be implemented in the training process.

It is noted that 3D supervised learning techniques may be optional and/or omitted in some implementations. Groundtruth 3D training data is not always available. In some implementations, 3D supervised learning techniques may be implemented if groundtruth 3D training data (e.g., 3D training data with FACS rigs) is available and may be omitted if no groundtruth 3D training data is available. However, using the techniques presented herein, it is possible to generate 2D training data, making it possible to train the modeling using the 2D training data, even if groundtruth 3D training data is not available.

As illustrated in FIG. 6, a neutral expression mesh 602 is provided as training data input to the conditional diffusion network 401. Previously generated 2D data based on the neutral expression mesh 602 may be used for supervision of the training process.

For example, groundtruth 2D images (e.g., groundtruth image 606) may be generated using the 2D animation model 500b based on the neutral expression mesh 602 or using other training images based upon facial expressions matching the target FACS weights for given poses. An output predicted mesh 608 obtained from the conditional diffusion network 401 may be compared to a groundtruth 3D mesh 604 (if such a groundtruth 3D mesh is available). 3D loss function values may be calculated to adjust parameters of the conditional diffusion network 401, thereby training the conditional diffusion network 401 to improve performance of the conditional diffusion network 401.

A rendered 2D image 610 may be rendered from the predicted mesh 608 using a differential rendering component or differential rendering process 612. The rendered 2D image 610 may be compared to the groundtruth 2D image 606 and 2D loss function values may be calculated to adjust the conditional diffusion network 401 accordingly.

For example, different 2D supervision losses may be implemented for model training. For the training data, a photometric loss may be used to calculate the difference between the rendered image [symbol] from predicted head mesh and groundtruth image Iₖ. A photometric loss is an error metric used in computer vision, primarily in self-supervised monocular depth and ego-motion estimation. A photometric loss measures the photometric (pixel-color) difference between a real image and a synthetically reconstructed one to train a neural network without ground-truth depth data. An example of a photo metric loss is illustrated in Equation 1, below.

$${L}_{photo} = \frac{1}{K} {\sum }_{k = 1}^{K} ( {I}_{k} - ) \qquad Equation 1$$

For rigged heads in the training data (e.g., heads with available FACS rigs), a 2D landmark loss and a 2D eye close loss may be incorporated into the training. Groundtruth landmarks in 3D may be obtained via labeling. Vertex correspondences between the neutral and the deformed mesh may be used to obtain the landmarks on the deformed mesh.

2D landmarks on the image can be obtained by projecting the 3D landmarks onto corresponding 2D landmarks. Additionally, in some implementations, groundtruth landmarks may be obtained for both 3D and 2D information through the correspondence between the neutral and deformed face mesh.

For the 2D landmark loss, the distance between the groundtruth 2D projected landmarks of groundtruth heads and the 2D projected landmarks of the deformed heads are calculated, as illustrated in Equation 2, below.

$${L}_{lmk} = {\sum }_{i = 1}^{N} \vert {k}_{i} - \prod ( {K}_{i} ) \vert \qquad Equation 2$$

In Equation 2, kᵢ is a groundtruth 2D landmark, Kᵢ is a 3D landmark of the predicted face, and Π( ) is a projection operation.

For the 2D eye-close loss, the relative offset of landmarks i and j on the upper and lower eyelid is calculated. The difference to the offset of the corresponding 3D landmarks on the deformed face projected into the image is measured, as illustrated in Equation 3, below. It is noted that the 2D eye-close loss is mainly used for poses including the left or right eye close shape, or only for those poses, in some implementations.

$${L}_{eye} = {\sum }_{( i , j ) ∈ E} \vert ( {k}_{i} - {k}_{j} ) - ( \prod ( {K}_{i} ) - \prod ( {K}_{j} ) ) \vert \qquad Equation 3$$

In Equation 3, E is the set of upper/lower eyelid landmark pairs.

In addition to these losses, other 2D supervision losses, such as perceptual loss, which measures the difference between features extracted by a pretrained image classification model from the groundtruth images and the predicted images, may also be used in some implementations. Additionally, incorporating dense contour-based supervision around the lips may help achieve more natural lip movements, in some implementations.

Upon calculation of losses and adjustment of the conditional diffusions network 401, further training may be executed until the model converges or it is otherwise determined that training may cease. The trained model may be deployed as a deformation prediction model as described above.

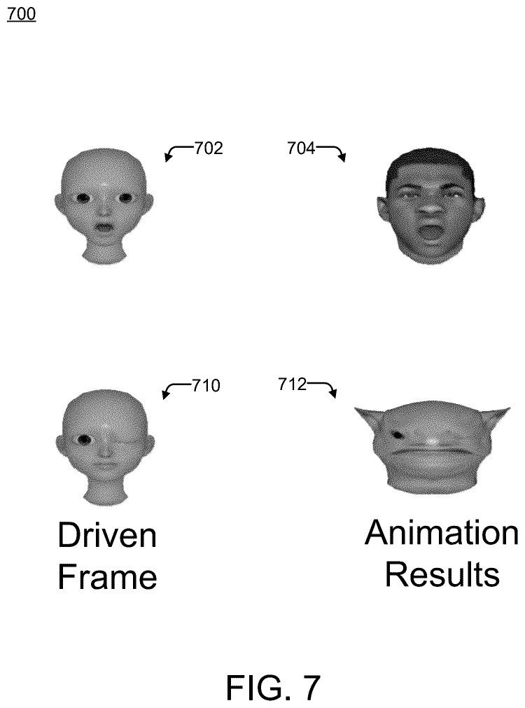

FIG. 7 illustrates experimental results obtained by implementing the dataset of FIG. 5A in conjunction with the methods illustrated in FIG. 5B and FIG. 5C, in accordance with some implementations. The faces illustrated in FIG. 7 did not include a rig. Therefore corresponding 3D groundtruth data was unavailable. However, as illustrated, animation results 704 and 712 accurately illustrate deformations as illustrated in the driven frames 702 and 710, respectively.

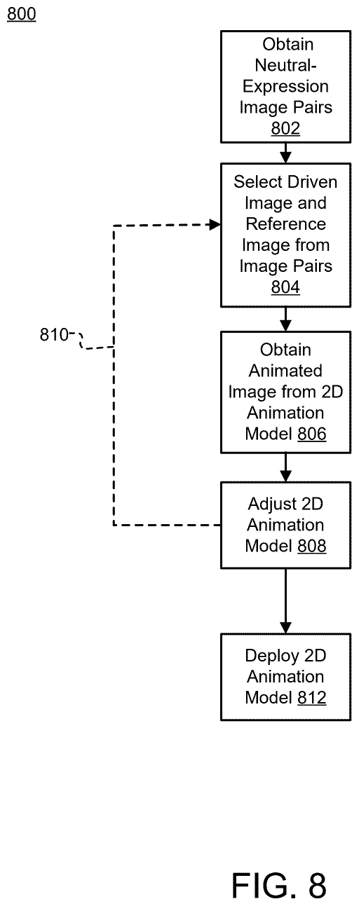

FIG. 8 is a flowchart of an example method 800 to train a 2D animation model, in accordance with some implementations.

In some implementations, method 800 can be implemented, for example, on a server 102 as described with reference to FIG. 1. In some implementations, some or all of the method 800 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 as shown in FIG. 1 or other storage). In some implementations, different components of one or more servers and/or clients can perform different blocks or other parts of the method 800. In some examples, a first device is described as performing blocks of method 800. Some implementations can have one or more blocks of method 800 performed by one or more other devices (e.g., other client devices or server devices) that can send results or data to the first device.

In some implementations, the method 800, or portions of the method 800, can be initiated automatically by a system. In some implementations, the implementing system is a first device. For example, the method (or portions thereof) can be periodically performed, or performed based on one or more particular events or conditions, e.g., upon a user request, upon a change in avatar head dimensions, upon a change in avatar head parts, a predetermined time period having expired since the last performance of method 800 for a particular model, and/or one or more other conditions occurring which can be specified in settings read by the methods.

Referring to FIG. 8, method 800 may begin at block 802. At block 802, neutral expression image pairs are obtained from rigged 3D heads or rigged 3D faces. For example, the neutral images may be obtained from rigged faces for training and unrigged faces for inference. In some implementations, all of the expression images may be from rigged images. Block 802 may be followed by block 804.

At block 804, a driven image is selected based on a target pose or a target expression, and a reference image is selected from the neutral image of the neutral expression image pairs. Block 804 may be followed by block 806.

At block 806, an animated image is obtained from the 2D animation model under training. Block 806 may be followed by block 808.

At block 808, the 2D animation model is adjusted. For example, adjustments may be based on a comparison of the output animated image produced in block 806 to one or more of the input images and/or based on any suitable loss functions (such as l1 and l2 losses). If training is to continue (e.g., if the model has not converged or if the training set is not exhausted), the method 800 may include iterating (illustrated with dotted line 810) between blocks 804, 806, and 808 until training is completed. If training is complete, block 808 is followed by block 812.

At block 812, the trained 2D animation model may be deployed. For example, the trained 2D animation model may be used to generate groundtruth 2D images for training of a deformation prediction model.

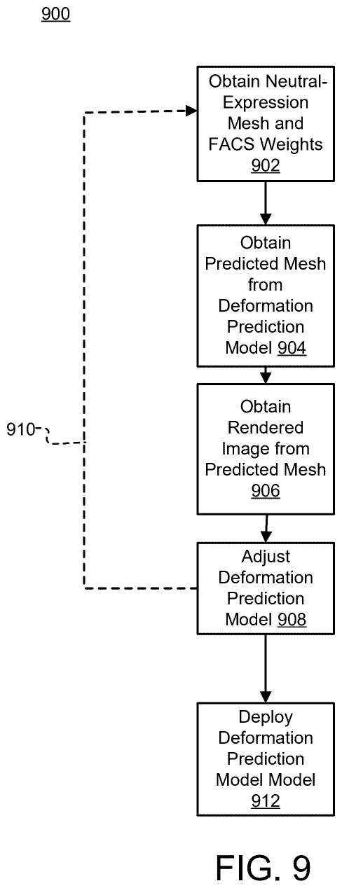

FIG. 9 is a flowchart of an example method 900 to train a deformation prediction model, in accordance with some implementations.

In some implementations, method 900 can be implemented, for example, on a server 102 described with reference to FIG. 1. In some implementations, some or all of the method 900 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 as shown in FIG. 1 or other storage). In some implementations, different components of one or more servers and/or clients can perform different blocks or other parts of the method 900. In some examples, a first device is described as performing blocks of method 900. Some implementations can have one or more blocks of method 900 performed by one or more other devices (e.g., other client devices or server devices) that can send results or data to the first device.

In some implementations, the method 900, or portions of the method 900, can be initiated automatically by a system. In some implementations, the implementing system is a first device. For example, the method (or portions thereof) can be periodically performed, or performed based on one or more particular events or conditions, e.g., upon a user request, upon a change in avatar head dimensions, upon a change in avatar head parts, a predetermined time period having expired since the last performance of method 900 for a particular model, and/or one or more other conditions occurring which can be specified in settings read by the methods.

It is noted that the system may not involve retraining for most changes in head dimensions because meshes are normalized prior to being fed to the model. Another condition that may involve retraining may be if the method may be extended to work on a wider variety of head styles, for example animal heads in addition to human or humanoid heads.

Referring to FIG. 9, method 900 may begin at block 902. At block 902, a neutral expression 3D mesh and a set of FACS weights are obtained. For example, the neutral expression 3D mesh may be selected from available 3D meshes, and the set of FACS weights may represent a target pose and/or a target expression of an output deformed mesh. Block 902 may be followed by block 904.

At block 904, a predicted mesh and/or predicted mesh deformations may be obtained from the deformation prediction model under training. Block 904 may be followed by block 906.

At block 906, a rendered 2D image may be obtained from a differential rendering component or through a differential rendering process, based upon the obtained predicted mesh and/or obtained predicted mesh deformations. Block 906 may be followed by block 908.

At block 908, the deformation prediction model may be adjusted. For example, adjustments may be based upon 2D supervision losses as described herein. Furthermore, in some implementations, 3D supervision losses may also be obtained and used in adjustments. For example, 3D supervision losses may be obtained and used if groundtruth 3D meshes are available and of sufficient quality.

If training is to continue (e.g., if the model has not converged), the method 900 may include iterating (illustrated with dotted line 910) between blocks 902, 904, 906, and 908 until training is completed. If training is completed, block 908 is followed by block 912.

At block 912, the trained deformation prediction model may be deployed. For example, the trained deformation prediction model may be deployed in a system similar to network environment 100 and/or as a portion of modeling component 130.

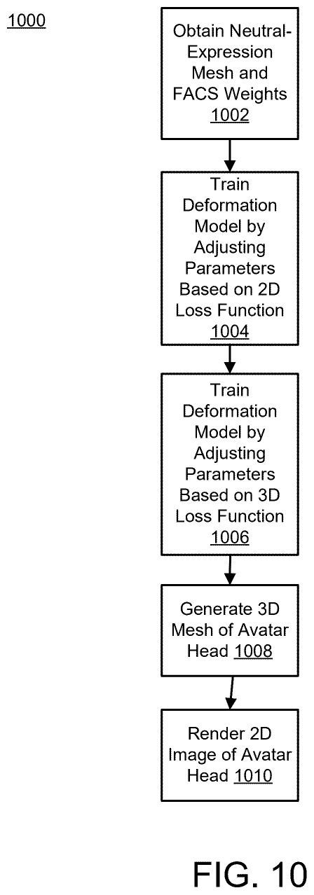

FIG. 10 is a flowchart of an example method 1000 to render an avatar head, in accordance with some implementations. Method 1000 may begin at block 1002.

At block 1002, a neutral-expression mesh and FACS weights are obtained. For example, the neutral-expression mesh may be a neutral three-dimensional (3D) mesh corresponding to an avatar head to be rendered.

The FACS weights may be a set of facial action coding system weights, where the set of FACS weights represent a particular facial pose or a particular facial expression for the avatar head. The set of facial action coding system (FACS) weights may be organized as a FACS vector. The FACS vector may be input to one or more of a plurality of conditional diffusion network blocks in the diffusion network. Block 1002 may be followed by block 1004.

At block 1004, a deformation model is trained by adjusting parameters based on a two-dimensional (2D) loss function. The training may further include training the deformation model by adjusting parameters of one or more of the plurality of conditional diffusion network blocks based on a value of a 2D loss function.

The value of the 2D loss function is based on a comparison of the 2D image of the avatar head with a groundtruth 2D image of the avatar head obtained from a trained 2D animation model, wherein the groundtruth 2D image of the avatar head has the particular facial pose or the particular facial expression. Additional details of such training are presented in the discussion of FIG. 8. Block 1004 may be followed by block 1006.

At block 1006, a deformation model is trained by adjusting parameters based on a three-dimensional (3D) loss function. The training may further include training the deformation model by adjusting parameters of one or more of the plurality of conditional diffusion network blocks based on a value of a 3D loss function.

The value of the 3D loss function is based on a comparison of the 3D mesh with a groundtruth 3D mesh of the avatar head that has the particular facial pose or the particular facial expression. Additional details of such training are presented in the discussion of FIG. 9. Block 1006 may be followed by block 1008.

At block 1008, a 3D mesh of the avatar head is generated. The 3D mesh of the avatar head may be generated using a deformation model. The neutral 3D mesh and the set of FACS weights are provided as inputs to the deformation model (for example, at trained deformation model). The 3D mesh at least partially matches the particular facial pose or the particular facial expression.

The deformation model is a machine-learning (ML) model trained to transform neutral 3D meshes of heads into 3D meshes with a target facial pose or a target facial expression. The avatar head is associated with an avatar that is part of a 3D virtual space, and further comprises rendering the avatar with the avatar head in the 3D virtual space.

The 3D virtual space may be a virtual experience hosted by a virtual experience platform or a preview space for viewing the avatar. The deformation model may be a machine-learning model that comprises a diffusion network. Such a diffusion network may include various constituent parts, as discussed in FIG. 2 and FIG. 4.

For example, the diffusion network may include a conditional diffusion portion comprising a first linear block, a plurality of conditional diffusion network blocks arranged in sequence following the first linear block, and a second linear block that follows a last conditional diffusion network block of the plurality of condition diffusion network blocks, a second portion comprising a global encoder, wherein an output of the global encoder is provided to one or more of the plurality of conditional diffusion network blocks, and a combine function that combines outputs of the conditional diffusion portion and 3D vertex positions (V) of the neutral three-dimensional (3D) mesh for the avatar head to generate the generated 3D mesh.

In some implementations, mesh information comprising the 3D vertex positions (V) and corresponding mesh faces (F) of the neutral 3D mesh are input to the first linear block of the conditional diffusion portion and to the global encoder.

In some implementations, the first linear block performs a first matrix multiplication using a first kernel of the mesh information to generate multiplied mesh information and applies a second kernel to convert a size of the multiplied mesh information to an input dimension that matches an input dimension for a first conditional diffusion block of the plurality of conditional diffusion network blocks.

In some implementations, a first set of features generated by the first matrix multiplication is provided as input to a first conditional diffusion network block of the plurality of conditional diffusion network blocks.

In some implementations, the second linear block performs a second matrix multiplication using a third kernel of output features from a final block of the conditional diffusion network blocks to generate multiplied output features and applies a fourth kernel to convert a size of the multiplied output features to match to a number of the 3D vertex positions.

In some implementations, the combine function modifies the 3D vertex positions from the mesh information using output features from the second linear block to generate a set of mesh deformations for the particular facial pose or the particular facial expression.

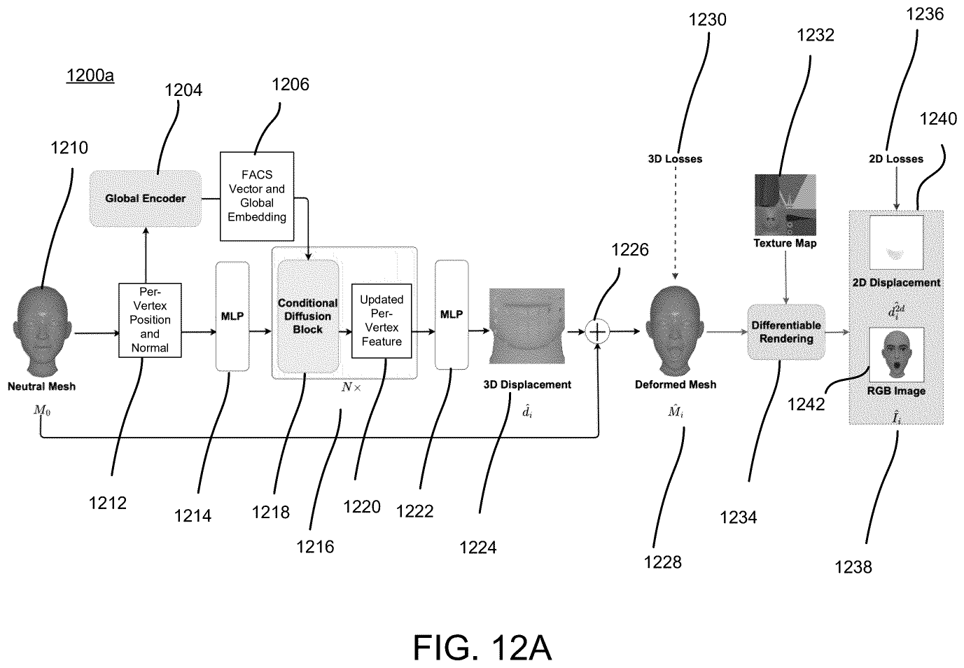

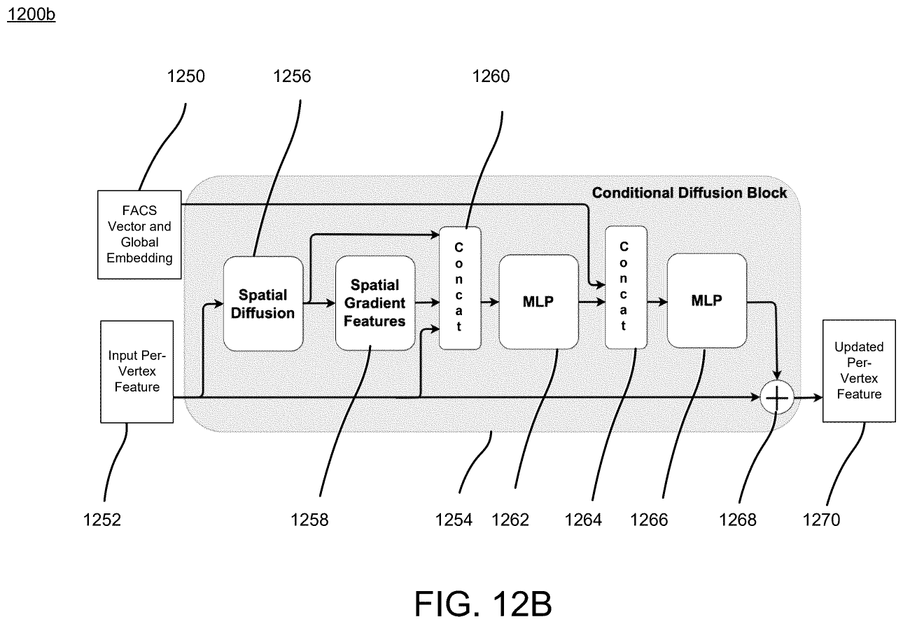

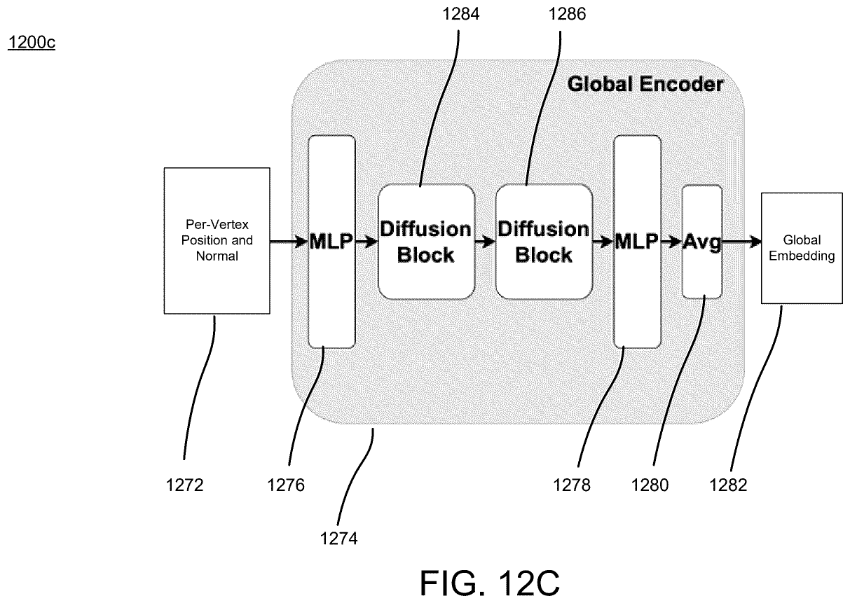

Additional aspects of the deformation model are discussed herein, such as at FIGS. 12A-12C. In various implementations, given a neutral facial mesh, the deformation model predicts the 3D displacement needed to deform the mesh into different expressions based on the input FACS vector. During training, 2D supervision is utilized for both rigged and unrigged heads, while 3D supervision is used for rigged heads. The deformation model used herein is improved by providing diffusion blocks that support the FACS vector as an additional conditional input. Additionally, there is a global encoder that processes vertex positions and normals of the neutral facial mesh to capture holistic information across disconnected components. Block 1008 may be followed by block 1010.

At block 1010, a 2D image of the avatar head is rendered. The 2D image of the avatar mesh may be rendered from the 3D mesh (the generated 3D mesh). To render a 2D image of an avatar head from a 3D mesh, a rendering engine for the virtual environment may perform a series of steps in tis graphics pipeline. The process converts the 3D model data into a flat, 2D representation that is displayed on a screen, combining geometry, textures, lighting, and camera positioning.

For example, the rendering may include operations such as 3D mesh processing, rigging and animation, texture mapping, scene setup, camera projection, lighting and shading, and rasterization and pixel processing. The rendering is not limited to these operations, and other operations may be included in addition to or instead of these enumerated operations. Additionally, some of these operations may be performed in different orders and/or in succession or using parallel processing. The final complete 2D image is then displayed on a screen.

FIG. 11 is a schematic 1100 illustrating an auto-rigging framework that supports facial meshes, in accordance with some implementations. The auto-rigging framework supports facial meshes of diverse topologies with multiple disconnected components such as eyeballs.

These meshes are drawn from diverse sources and may cover both humanoid and non-humanoid heads. Given a neutral facial mesh and explicitly controllable FACS parameters specifying activated action units, the auto-rigging framework accurately deforms the input mesh into corresponding FACS poses, creating an expressive blendshape rig.

FIG. 11 illustrates examples of neutral facial meshes 1102. The neutral facial meshes 1102 may include wireframe data 1122 and textured mesh data 1124 for the neutral facial meshes 1102. For example, such data (wireframe data 1122 and textured mesh data 1124) may be provided for a first avatar head 1110, a second avatar head 1114, and a third avatar head 1118.

FIG. 11 also illustrates additional aspects of the auto-rigging framework. For example, there is a face deformation model 1104, which is presented as including a neural network. In addition to the neutral facial meshes 1102, face deformation model 1104 receives explicitly controllable FACS parameters 1126. For example, these explicitly controllable FACS parameters 1126 may be adjusted in a range, from minimum incorporation of the given parameter to total incorporation of the given parameter.

For example, the FACS parameters 1126 may include jaw drop, right eye close, left eye close, pucker, funneler, lip presser, eye look up, and eye look down as non-limiting examples. There may be additional FACS parameters 1126, or some of the illustrated FACS parameters 1126 may be omitted.

The face deformation model 1104 produces FACS blendshapes 1106 as results. For example, the FACS blendshapes 1106 include first blendshapes 1112 corresponding to first avatar head 1110, second blendshapes 1116 corresponding to second avatar head 1114, and third blendshapes 1120 corresponding to third avatar head 1118.

Each of the blendshapes illustrates examples of adjusting a particular FACS parameter. For example, blendshapes 1128 illustrate jaw drop results, blendshapes 1130 illustrate left eye close results, blendshapes 1132 illustrate mouth funnel results, and blendshapes 1134 s illustrate right lip corner puller results.

FIG. 12A is a schematic illustrating a facial mesh deformation model 1200a, in accordance with some implementations. Given a neutral facial mesh, the deformation model predicts the 3D displacement used to deform the mesh into different expressions based on the input FACS vector. During training, 2D supervision is utilized for both rigged and unrigged heads, while 3D supervision is exclusively applied to rigged heads.

FIG. 12A is a version of a diffusion network. FIG. 12A illustrates a workflow of a facial mesh deformation model 1200a. The network is built around learned diffusion, pointwise perceptrons, spatial gradient features, and discretization agnosticism.

The workflow begins with receipt of a neutral mesh 1210. The neutral mesh 1210 is transformed into a per-vertex position and normal data 1212. The per-vertex position and normal data 1212 is provided to a global encoder 1204 and to a multi-layer perceptron (MLP) 1214. The global encoder 1204 transforms the per-vertex position and normal data 1212 into a FACS vector (Aᵢ) and a Global Embedding (G₀) 1206. The diffusion network may also use mesh operators in order to compute the diffusion operation and the spatial gradients as shown in FIG. 12B.

The FACS vector and Global Embedding 1206 and the output of MLP 1214 are provided to N conditional diffusion blocks 1216, wherein each of the blocks includes an individual conditional diffusion block 1218 that provides an updated per-vertex feature 1220. The conditional diffusion blocks 1216 are also referred to herein, such as in FIG. 4, as conditional diffusion network blocks. Additional details of the blocks (along with how the blocks are configured) are discussed in FIG. 12B.

The N conditional diffusion blocks 1216 each provide an output, which is provided to a second MLP 1222. MLP 1222 provides 3D displacement information 1224, where a combination unit 1226 uses residual connections to combine the neutral mesh 1210 (M₀) with the 3D displacement information (\hat{d}ᵢ) 1224, yielding a deformed mesh 1228. Such residual connections add the output of a layer or block to its initial input, helping to stabilize training and improve performance.

The deformed mesh 1228 may also receive information about 3D losses 1230. Such information is used for rigged heads. The deformed mesh (\hat{M}ᵢ) 1228 is used for differentiable rendering 1234 along with texture map information 1232. The results of differentiable rendering 1234 are provided, along with 2D losses 1236, to provide final results 1238. Final results 1238 may include 2D displacement information ( [symbol] ) 1240 and an RGB image ( [symbol] ) 1242.

As illustrated in FIG. 12A, the deformation network takes the neutral facial mesh M₀= (V₀, F) and a FACS pose vector Aᵢ as inputs and predicts the displacement \hat{d}ᵢ used to deform the neutral mesh into the corresponding posed mesh [symbol] =( [symbol] , F), where [symbol] =V₀+ [symbol] . The posed meshes obtained for the FACS poses together form a linear FACS blendshape rig.

Implementations may build the deformation network upon diffusion networks to take advantage of the triangulation-agnostic property of such networks. Implementations may be able to handle multiple disconnected components by propagating information between such components.

Such alternative diffusion networks are also limited to processing a single mesh without additional input. The present techniques provide the ability to deform facial meshes with multiple disconnected components conditioned on an additional input, the FACS vector. To this end, various implementations introduce two configuration features to the alternative diffusion network. The global encoder 1204 is configured as illustrated in FIG. 12C. The conditional diffusion block 1218 is configured as illustrated in FIG. 12B.

Relying solely on fully rigged heads limits the training dataset size due to the scarcity of high-quality 3D groundtruth data, which hampers generalization to unseen facial meshes. 2D supervision is more readily available thanks to advancements in 2D generation models, enabling the inclusion of unrigged heads to scale up the training dataset to enhance generalization. Thus, implementations use 2D supervision for the face auto-rigging network in terms of appearance and motion variation.

Specifically, for appearance data, implementations use the front-view image and binary segmentation mask of the posed head as supervision. The implementations render the RGB image [symbol] and binary mask [symbol] of the predicted mesh [symbol] onto the 2D image plane using differentiable rendering. The image loss L_{img} and mask loss Lₘₐₛₖ are defined as the l1 distances between [symbol] with the ground-truth image Iᵢ and between [symbol] with the groundtruth mask Bᵢ, respectively.

Using appearance-level supervisions like image and mask losses provides a straightforward way to optimize the 3D deformation network using 2D supervision. These losses offer strong supervisory signals for poses that result in significant changes in pixel color values. However, many target FACS poses involve subtle expressions, where changes are less visually apparent.

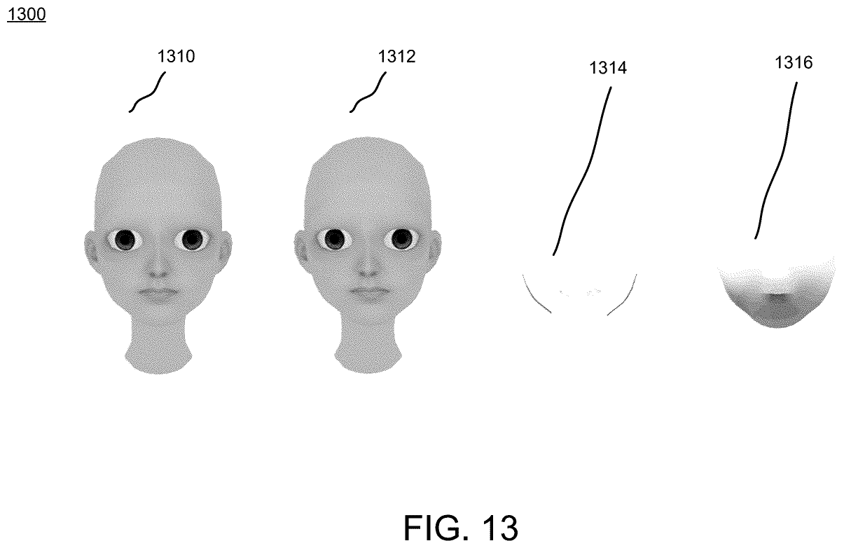

For instance, as illustrated in FIG. 13, comparing the neutral image 1310 in FIG. 13 with the jaw-left pose image 1312 in FIG. 13, the differences are barely noticeable to the human eye. Similarly, as illustrated in FIG. 13, the pixel error map of pixel color differences 1314 on RGB values between these two images highlights that only a small portion of pixels contribute meaningful supervisory feedback for these subtle deformations. In other words, the magnitude of the loss remains minimal, even if the deformation model leaves the vertices fixed in the neutral expression.

To address this challenge, implementations introduce another 2D supervision for the 3D deformation model based on pixel motions. Specifically, in implementations, the 2D displacement

$${d}_{i}^{2 d}$$

is defined as the offset of each pixel on the image plane between the neutral and posed images. Such a displacement is analogous to optical flow, where optical flow is the apparent motion of objects or surfaces in a visual scene caused by the relative movement between an observer (camera) and a scene.

This 2D displacement is computed from the 3D displacement dᵢ in a fully differentiable manner with differentiable rendering. As illustrated in FIG. 13, the 2D displacement 1316 is more distinguishable for subtle facial expressions because the 2D displacement 1316 explicitly represents the motion of each pixel in a 2D context, rather than relying on RGB value changes.

This approach is particularly beneficial in areas with a uniform texture, such as a cheek, where RGB value changes may be unnoticeable. In implementations, the 2D displacement loss L_{dis-2d} may be defined as the l2 distance between the groundtruth 2D displacement

$${d}_{i}^{2 d}$$

and the predicted 2D displacement [symbol] .

For rigged heads, it is possible to obtain the above 2D supervisions by rendering from 3D groundtruth. However, for unrigged heads, this supervision is not feasible due to the absence of complete 3D groundtruth deformations. To this end, recent advancements in 2D generation models are leveraged to generate 2D supervision for unrigged heads. These 2D models effectively distill appearance and motion priors from large-scale 2D image and video datasets. The 2D models generale well across diverse scenarios.

A 2D face animation diffusion model is used for achieving such results. As illustrated in FIG. 5B and FIG. 5C, this model (for example, diffusion-based 2D animation model 552) takes a neutral reference image rendered from an unrigged head (for example, neutral image 550) and a driving posed image rendered from a rigged head (for example, driving image 558), animating the neutral image to replicate the expression in the posed image while preserving its identity. The generated images (for example, generated image 554) serve as image-based groundtruth data for unrigged heads during the training of the 3D deformation model.

In practice, one rigged head is selected, the FACS poses images for the selected head are rendered, and these pose images are used as driving images to generate corresponding posed images for the unrigged heads. Groundtruth masks may be obtained using an image segmentation model, as the generated images are provided with a clean white background. For the 2D displacement, an optical flow estimation model is used to predict pixel offsets between the neutral image and the generated posed image of unrigged heads. These offsets serve as the groundtruth 2D displacements for training the 3D deformation model.

To enhance the performance of the 2D face animation and flow estimation models on stylized faces in the artist-crafted dataset, the pre-trained weights are fine-tuned using the groundtruth renderings from a small set of rigged heads, improving effectiveness. The dataset is obtained with artist permission for use to train models and in compliance with applicable rules and laws, and with specific artist consent. The dataset may be created as a commissioned work for the purpose of training models.

The network is trained in a two-stage, coarse-to-fine manner. In the first stage, the 3D deformation network is trained on a large-scale dataset comprising both rigged and unrigged heads, using 2D supervision alone. The first stage uses a combination of photometric loss and 2D displacement loss, along with a l2 regularization loss, L_{reg} on the predicted 3D displacement.

This regularization loss helps to improve model convergence speed and prevent “flying points” for non-line-of-sight vertices. Flying points refer to vertices that incorrectly get deformed to positions far away from neutral positions because the 2D losses alone cannot restrict the deformation of all vertices. For example, vertices that are not visible when rendering an image are not able to get reliable information from the 2D losses, and this is why the regularization loss is used. The total training loss for the first stage is defined as: Lₛ₁=α₁L_{img}+α₂Lₘₐₛₖ+α₃L_{dis-2d}+α₄L_{reg}, where a are weighting parameters for different loss terms.

In the second stage, the pretrained model is fine-tuned from the first stage using only rigged heads, incorporating both 2D and 3D supervision to achieve high-precision deformation predictions. Because the 3D groundtruth deformed mesh Mᵢ=(Vᵢ, F) for a FACS pose i is available for rigged heads, 3D supervision is incorporated by applying the mean square error (MSE) loss L_{msc-3d} in 3D space between the groundtruth and predicted mesh vertices Vᵢ and \hat{V}ᵢ.

For 2D supervision, in addition to the image loss and the mask loss, two loss terms are added, specifically landmark loss Lᵢₘₖ and eye close loss L_{ec}, to provide supervision for specific facial landmarks and poses. The 2D displacement loss is omitted in this stage because the 3D displacement groundtruth information is available. The total training loss for the second stage is defined as: Lₛ₂=α₁L_{img}+α₂Lₘₐₛₖ+α₃L_{msc-3d}+α₄Lᵢₘₖ+α₅L_{ec}. After the two stages, the pretrained model is ready for deployment.

FIG. 12B is a schematic 1200b illustrating details of a conditional diffusion block 1254, in accordance with some implementations. In the conditional diffusion block 1254, an original diffusion block in is configured to support the FACS vector as an additional conditional input. The original diffusion block in a diffusion network is configured to integrate a FACS pose vector as a conditional input, guiding the diffusion network's generation of facial expressions. This permits the diffusion network to be trained to learn the relationship between FACS values and corresponding mesh deformations.

As illustrated in FIG. 12B, the FACS pose vector Aᵢ is concatenated with the global feature vector G₀ to create a latent representation (for example, FACS vector and global embedding data 1250). This latent representation is then injected into each conditional diffusion block of the main network. Within each block, the latent vector is replicated across the vertex dimension and fused with the block's output features. This fused information is then processed by a small MLP (for example, MLP 1266) to refine the mesh's latent features.

FIG. 12B illustrates a conditional diffusion block 1254, corresponding to conditional diffusion block 1218 of FIG. 12A. As discussed herein, the architecture of the conditional diffusion block 1254 is configured to support the FACS vector as an additional conditional input. Each conditional diffusion block 1254 performs learned diffusion, uses spatial gradient features, and passes the results through an MLP to learn high-frequency, non-linear functions at each point.

For example, FIG. 12B illustrates a FACS vector and global embedding data 1250 as input, as well as input per-vertex feature 1252. Input per-vertex feature 1252 is subject to spatial diffusion 1256. The spatial diffusion 1256 produces spatial gradient features 1258, which are subject to a first concatenation operation 1260, where the first concatenation operation 1260 concatenates the input per-vertex feature 1252, the results of the spatial diffusion 1256, and the spatial gradient features 1258.

The results of first concatenation operation 1260 are provided to a multi-layer perceptron (MLP) 1262, and the output of MLP 1262 are subject to a second concatenation operation 1264, where the second concatenation operation 1264 concatenates the output of MLP 1262 with FACS vector and global embedding data 1250.

The results of second concatenation operation 1264 are provided to a final MLP 1266, and the results of the final MLP 1266 are provided to a combination operator 1268 along with the input per-vertex feature 1252. The combination operator 1268 provides a residual connection for the given conditional diffusion block 1254 that adds the output of the conditional diffusion block 1254 to its initial input, helping to stabilize training and improve performance.

The combination operator 1268 provides the output of the given conditional diffusion block 1254, yielding an updated per-vertex feature 1270. The updated per-vertex feature 1270 is provided to the next conditional diffusion block or to an MLP (for example, MLP 1222 in FIG. 12A) depending on how many conditional diffusion blocks have been processed (up to a total of N conditional diffusion blocks).

FIG. 12C is a schematic 1200c illustrating details of a global encoder 1274, in accordance with some implementations. In the global encoder 1274, the global encoder 1274 processes vertex positions and normals of the neutral facial mesh to capture holistic information across disconnected components. This branch (corresponding to global encoder 1204 of FIG. 12A) consists of a smaller 2-layer diffusion network that process the input neural mesh. Global average pooling is applied to the final layer's per-vertex features, producing a single vector encoding G₀ that compresses information about the mesh into a global feature vector.

For example, global encoder 1274 receives as input per-vertex position and normal data 1272. The input per-vertex position and normal data 1272 is initially subject to a first MLP 1276. The first MLP 1276 is known as the pointwise perceptron and is responsible for transforming the input features at each individual point to permit the network to learn rich, non-linear functions based on the local, per-point data.

The output of first MLP 1276 is provided to first diffusion block 1284 and second diffusion block 1286. First diffusion block 1284 primarily handles local information propagation. Second diffusion block 1286 focuses on long-range, global communication. Together, the blocks provide discretization agnosticism, adaptive spatial support, and directional filters.

The output of second diffusion block 1286 is provided to second MLP 1278, which processes the aggregated features that now contain information from the surrounding spatial neighborhood, due to the preceding diffusion and gradient steps. As discussed above, the output of second MLP 1278 is subject to average pooling 1280, yielding a global embedding 1282 that is a single vector encoding G₀ that compresses information about the mesh into a global feature vector.

FIG. 13 is an illustration of examples of 2D displacement supervision 1300, in accordance with some implementations. FIG. 13 illustrates neutral image 1310, posed image 1312, pixel color difference 1314, and 2D displacement field 1316. As discussed above, it may be difficult to distinguish between neutral image 1310 and posed image 1312, such that pixel color difference 1314 does not provide a lot of useful information. Hence, 2D displacement field 1316 may do a better job of communicating how neutral image 1310 and posed image 1312 differ from one another.

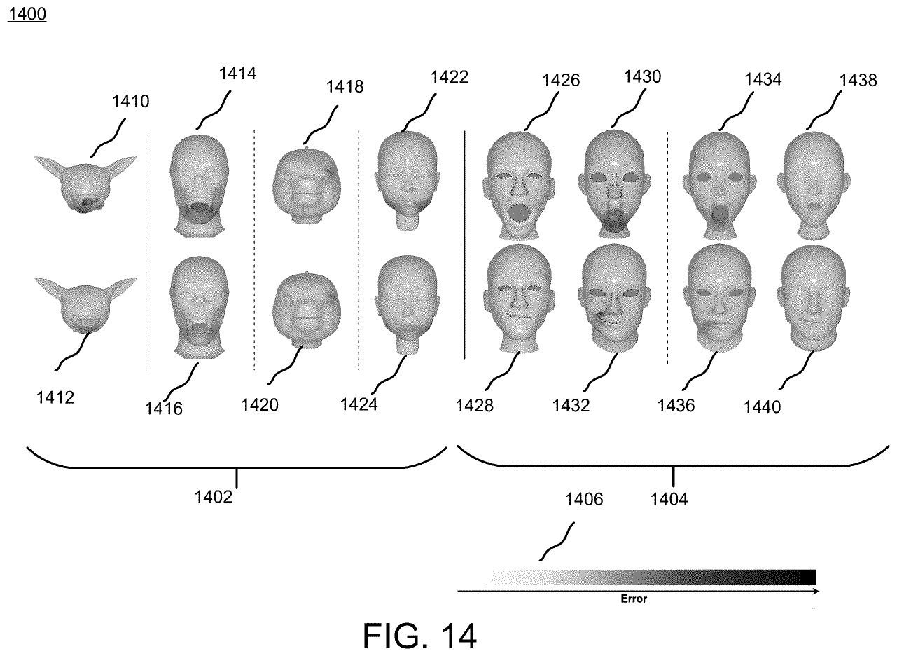

FIG. 14 is an illustration of results obtained using various methods and/or models described herein, in accordance with some implementations. FIG. 14 illustrates ablation on framework components 1402 and a comparison of results with alternative techniques 1404. FIG. 1406 also illustrates a spectrum 1406 corresponding to shading indicating various levels of error.

FIG. 14 illustrates mesh 1410 and mesh 1412 (illustrating the role of a global encoder), mesh 1414 and mesh 1416 (illustrating the role of 2D loss), mesh 1418 and mesh 1420 (illustrating the role of rigged heads), and mesh 1422 and mesh 1424 (illustrating the role of 2D displacement).

Mesh 1410 is without a global encoder and mesh 1412 is with a global encoder. These meshes illustrate that without using the global encoder, disconnected parts may intersect.

Mesh 1414 is without a 2D loss and mesh 1416 is with a 2D loss. These meshes illustrate that using the 2D loss decreases errors.

Mesh 1418 is without unrigged heads and mesh 1420 is with unrigged heads. These meshes illustrate that using additional unrigged heads improves generalization, addressing challenging cases such as animal eye closure.

Mesh 1422 is without a 2D displacement and mesh 1424 is with a 2D displacement. These meshes illustrate that using 2D displacement further refines subtle poses such as “Jaw Left.”

FIG. 14 also illustrates certain results provided by methods defined herein as compared to alternative methods. FIG. 14 illustrates a first reference avatar head 1426 and a second reference avatar head 1428. The first reference avatar head 1426 corresponds to first deformation transfer 1430, first NFR results 1434, and first results 1438 in accordance with techniques provided herein.

The second reference avatar head 1428 corresponds to second deformation transfer 1432, second NFR results 1436, and second results 1440 in accordance with techniques provided herein.

FIG. 14 illustrates that the techniques provided herein achieve more accurate and expressive animation results while handling multiple disconnected components. Reference mesh and corresponding points are provided for deformation transfer in FIG. 14.

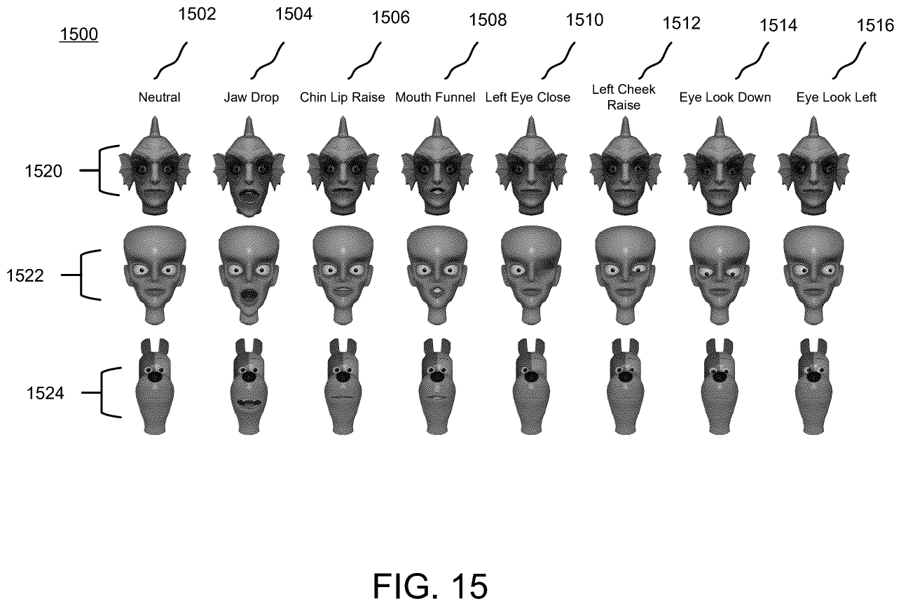

FIG. 15 is an illustration of results on artist-crafted unrigged heads 1500, in accordance with some implementations. FIG. 15 illustrates three groups of avatar heads, group A 1520, group B 1522, and group C 1524. Group A 1520 corresponds to variants of a merman avatar head, group B 1522 corresponds to variants of an alien avatar head, and Group C 1524 corresponds to variants of a dog avatar head.

FIG. 15 illustrates variants for these groups. For example, each group is associated with a neutral pose 1502, a jaw drop pose 1504, a chin lip raise pose 1506, a mouth funnel pose 1508, a left eye close pose 1510, a left cheek raise pose 1512, an eye look down pose 1514, and an eye look left pose 1516. FIG. 15 illustrates that techniques presented herein generalize effectively to in-the-wild facial meshes with diverse topology and shape variations.

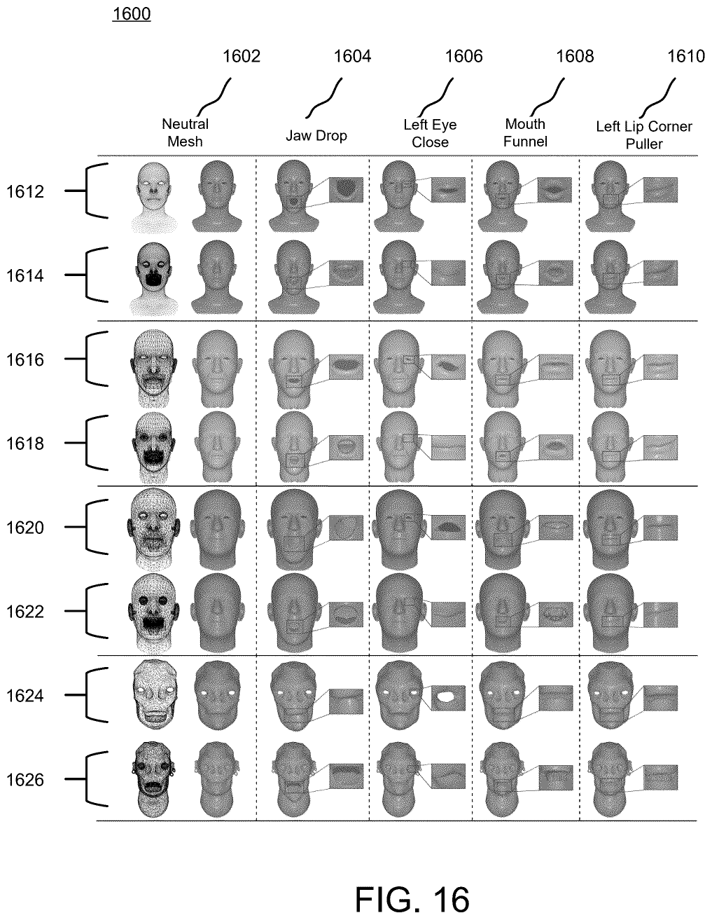

FIG. 16 is an illustration 1600 of results comparing auto-rigging results per techniques described herein with results from an alternative technique, in some implementations. The method generalizes effectively to in-the-wild facial meshes with diverse topology and shape variations. The examples include neutral mesh examples (including a wireframe and a corresponding textured mesh) 1602, jaw drop examples 1604, left eye close examples 1606, mouth funnel examples 1608, and left lip corner puller examples 1610.

To demonstrate this, FIG. 16 presents qualitative results on samples 1612 and 1614 from a first dataset, samples 1616 and 1618 from a second dataset, humanoid samples 1620 and 1622 from a third dataset, and non-humanoid samples 1624 and 1626 from a third dataset. In the examples, samples 1612, 1616, 1620, and 1624 were produced by NFR and samples 1614, 1618, 1622, and 1626 were produced by techniques provided herein.

As illustrated in FIG. 16, the model provided herein consistently achieves better accuracy and generalizability. In particular, NFR was trained on the first dataset and the model provided herein was not, the results achieved in the provided herein in the samples 1614 are comparable to those of samples 1612.

For humanoid assets from the second dataset and the third dataset, neither the techniques provided herein nor NFR were trained on data from these sources, but the present techniques demonstrate superior performance on input from both datasets (samples 1618 are superior to samples 1616, and samples 1622 are superior to samples 1620). For the non-humanoid head from the third dataset, NFR leaves the non-humanoid head largely undeformed, whereas the model discussed herein successfully generalizes to the challenging case of the non-humanoid head (given that samples 1624 do not generalize while samples 1626 generalize).

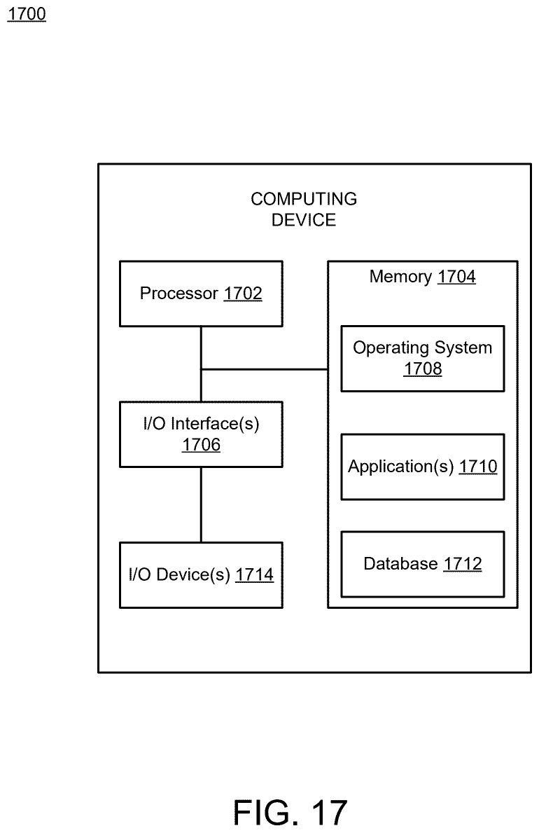

FIG. 17 is a block diagram illustrating an example computing device, in accordance with some implementations.

Hereinafter, a more detailed description of various computing devices that may be used to implement different devices and/or components illustrated in FIG. 1 is provided with reference to FIG. 17.

FIG. 17 is a block diagram of an example computing device 1700 which may be used to implement one or more features described herein, in accordance with some implementations. In one example, device 1700 may be used to implement a computer device, (e.g., server 102, client device 110 of FIG. 1), and perform appropriate operations as described herein. Computing device 1700 can be any suitable computer system, server, or other electronic or hardware device. For example, the computing device 1700 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1700 includes a processor 1702, a memory 1704, input/output (I/O) interface 1706, and audio/video input/output devices 1714 (e.g., display screen, touchscreen, display goggles or glasses, audio speakers, headphones, microphone, etc.).

Processor 1702 can be one or more processors and/or processing circuits to execute program code and control basic operations of the device 1700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1704 is typically provided in device 1700 for access by the processor 1702, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1702 and/or integrated therewith. Memory 1704 can store software operating on the server device 1700 by the processor 1702, including an operating system 1708, software application 1710 and associated database 1712. In some implementations, the applications 1710 can include instructions that enable processor 1702 to perform the functions described herein. Software application 1710 may include some or all of the functionality required to implement and train deformation prediction models, 2D animation models, and others. In some implementations, one or more portions of software application 1710 may be implemented in dedicated hardware such as an application-specific integrated circuit (ASIC), a programmable logic device (PLD), a field-programmable gate array (FPGA), a machine learning processor, etc. In some implementations, one or more portions of software application 1010 may be implemented in general purpose processors, such as a central processing unit (CPU) or a graphics processing unit (GPU). In various implementations, suitable combinations of dedicated and/or general-purpose processing hardware may be used to implement software application 1710.

For example, software application 1710 stored in memory 1704 can include instructions for retrieving user data, for displaying/presenting avatars heads or head parts, and/or other functionality or software such as the modeling component 130, VE Engine 104, and/or VE Application 112. Any of the software in memory 1704 can alternatively be stored on any other suitable storage location or computer-readable medium. In addition, memory 1704 (and/or other connected storage device(s)) can store instructions and data used in the features described herein. Memory 1704 and any other type of storage (magnetic disk, optical disk, magnetic tape, or other tangible media) can be considered “storage” or “storage devices.”

I/O interface 1706 can provide functions to enable interfacing the server device 1700 with other systems and devices. For example, network communication devices, storage devices (e.g., memory and/or data store 106), and input/output devices can communicate via interface 1706. In some implementations, the I/O interface 1706 can connect to interface devices including input devices (keyboard, pointing device, touchscreen, microphone, camera, scanner, etc.) and/or output devices (display device, speaker devices, printer, motor, etc.).

For ease of illustration, FIG. 17 shows one block for each of processor 1702, memory 1704, I/O interface 1706, software blocks 1708 and 1710, and database 1712. These blocks may represent one or more processors or processing circuitries, operating systems, memories, I/O interfaces, applications, and/or software modules. In other implementations, device 1700 may not have all of the components shown and/or may have other elements including other types of elements instead of, or in addition to, those shown herein. While the online server 102 are described as performing operations as described in some implementations herein, any suitable component or combination of components of online server 102, or similar system, or any suitable processor or processors associated with such a system, may perform the operations described.

A user device can also implement and/or be used with features described herein. Example user devices can be computer devices including some similar components as the device 1700, e.g., processor(s) 1702, memory 1704, and I/O interface 1706. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1714, for example, can be connected to (or included in) the device 1700 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., methods 600, 800, 900, and 1000) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to render an avatar head, the method comprising:
obtaining a neutral three-dimensional (3D) mesh of the avatar head and a set of facial action coding system (FACS) weights, wherein the set of FACS weights represent a particular facial pose or a particular facial expression for the avatar head;
generating a 3D mesh of the avatar head using a deformation model, wherein the neutral 3D mesh and the set of FACS weights are provided as inputs to the deformation model, and wherein the 3D mesh at least partially matches the particular facial pose or the particular facial expression; and
rendering a two-dimensional (2D) image of the avatar head from the generated 3D mesh.

2. The computer-implemented method of claim 1, wherein the deformation model is a machine-learning model trained to transform neutral 3D meshes of heads into 3D meshes with a target facial pose or a target facial expression, and wherein the avatar head is associated with an avatar that is part of a 3D virtual space, and further comprising rendering the avatar with the avatar head in the 3D virtual space.

3. The computer-implemented method of claim 2, wherein the 3D virtual space is a virtual experience hosted by a virtual experience platform or a preview space for viewing the avatar.

4. The computer-implemented method of claim 1, wherein the deformation model is a machine-learning model that comprises a diffusion network.

5. The computer-implemented method of claim 4, wherein the diffusion network comprises:
a conditional diffusion portion comprising a first linear block, a plurality of conditional diffusion network blocks arranged in sequence following the first linear block, and a second linear block that follows a last conditional diffusion network block of the plurality of conditional diffusion network blocks;
a second portion comprising a global encoder, wherein an output of the global encoder is provided to one or more of the plurality of conditional diffusion network blocks; and
a combine function that combines outputs of the conditional diffusion portion and 3D vertex positions (V) of the neutral 3D mesh for the avatar head to generate the generated 3D mesh.

6. The computer-implemented method of claim 5, wherein mesh information comprising the 3D vertex positions (V) and corresponding mesh faces (F) of the neutral 3D mesh are input to the first linear block of the conditional diffusion portion and to the global encoder.

7. The computer-implemented method of claim 6, wherein the first linear block performs a first matrix multiplication using a first kernel of the mesh information to generate multiplied mesh information and applies a second kernel to convert a size of the multiplied mesh information to an input dimension that matches an input dimension for a first conditional diffusion block of the plurality of conditional diffusion network blocks.

8. The computer-implemented method of claim 7, wherein a first set of features generated by the first matrix multiplication is provided as input to a first conditional diffusion network block of the plurality of conditional diffusion network blocks.

9. The computer-implemented method of claim 7, wherein the second linear block performs a second matrix multiplication using a third kernel of output features from a final block of the conditional diffusion network blocks to generate multiplied output features and applies a fourth kernel to convert a size of the multiplied output features to match to a number of the 3D vertex positions.

10. The computer-implemented method of claim 6, wherein the combine function modifies the 3D vertex positions from the mesh information using output features from the second linear block to generate a set of mesh deformations for the particular facial pose or the particular facial expression.

11. The computer-implemented method of claim 5, wherein the set of facial action coding system (FACS) weights are organized as a FACS vector, and wherein the FACS vector is input to one or more of the plurality of conditional diffusion network blocks.

12. The computer-implemented method of claim 5, further comprising training the deformation model by adjusting one or more parameters of one or more of the plurality of conditional diffusion network blocks based on a value of a 2D loss function, wherein the value of the 2D loss function is based on a comparison of the 2D image of the avatar head with a groundtruth 2D image of the avatar head obtained from a trained 2D animation model, wherein the groundtruth 2D image of the avatar head has the particular facial pose or the particular facial expression.

13. The computer-implemented method of claim 5, further comprising training the deformation model by adjusting one or more parameters of one or more of the plurality of conditional diffusion network blocks based on a value of a 3D loss function, wherein the value of the 3D loss function is based on comparison of the 3D mesh with a groundtruth 3D mesh of the avatar head that has the particular facial pose or the particular facial expression.

14. A non-transitory computer-readable medium that has instructions stored thereon that, responsive to execution by a processing device, cause the processing device to perform or control performance of operations comprising:
obtaining a neutral three-dimensional (3D) mesh of an avatar head and a set of facial action coding system (FACS) weights, wherein the set of FACS weights represent a particular facial pose or a particular facial expression for the avatar head;
generating a 3D mesh of the avatar head using a deformation model, wherein the neutral 3D mesh and the set of FACS weights are provided as inputs to the deformation model, and wherein the 3D mesh at least partially matches the particular facial pose or the particular facial expression; and
rendering a two-dimensional (2D) image of the avatar head from the generated 3D mesh.

15. The non-transitory computer-readable medium of claim 14, wherein the deformation model is a machine-learning model trained to transform neutral 3D meshes of heads into 3D meshes with a target facial pose or a target facial expression, and wherein the avatar head is associated with an avatar that is part of a 3D virtual space, and wherein the operations further comprise rendering the avatar with the avatar head in the 3D virtual space.

16. The non-transitory computer-readable medium of claim 14, wherein the deformation model is a machine-learning model that comprises a diffusion network.

17. The non-transitory computer-readable medium of claim 16, wherein the diffusion network comprises:
a conditional diffusion portion comprising a first linear block, a plurality of conditional diffusion network blocks arranged in sequence following the first linear block, and a second linear block that follows a last conditional diffusion network block of the plurality of conditional diffusion network blocks;
a second portion comprising a global encoder, wherein an output of the global encoder is provided to one or more of the plurality of conditional diffusion network blocks; and
a combine function that combines outputs of the conditional diffusion portion and 3D vertex positions (V) of the neutral 3D mesh for the avatar head to generate the generated 3D mesh.

18. A system comprising:
a memory with instructions stored thereon; and
a processing device, coupled to the memory, the processing device configured to access the memory and execute the instructions, wherein the instructions cause the processing device to perform or control performance of operations comprising:
obtaining a neutral three-dimensional (3D) mesh of an avatar head and a set of facial action coding system (FACS) weights, wherein the set of FACS weights represent a particular facial pose or a particular facial expression for the avatar head;
generating a 3D mesh of the avatar head using a deformation model, wherein the neutral 3D mesh and the set of FACS weights are provided as inputs to the deformation model, and wherein the 3D mesh at least partially matches the particular facial pose or the particular facial expression; and
rendering a two-dimensional (2D) image of the avatar head from the generated 3D mesh.

19. The system of claim 18, wherein the deformation model is a machine-learning model trained to transform neutral 3D meshes of heads into 3D meshes with a target facial pose or a target facial expression, and wherein the avatar head is associated with an avatar that is part of a 3D virtual space, and wherein the operations further comprise rendering the avatar with the avatar head in the 3D virtual space.

20. The system of claim 18, wherein the deformation model is a machine-learning model that comprises a diffusion network.
